(19) United States
(12) Patent Application Publication
(10) Pub. No.: US 2013/0082985 A1
(43) Pub. Date: Apr. 4, 2013

(54) CONTENT DISPLAY APPARATUS, AND CONTENT DISPLAY METHOD

(71) Applicant: Shuhei SASAKURA, Osaka (JP)

(72) Inventor: Shuhei SASAKURA, Osaka (JP)

(21) Appl. No.: 13/585,098

(22) Filed: Aug. 14, 2012

Related U.S. Application Data
(63) Continuation of application No. PCT/JP2011/007276, filed on Dec. 26, 2011.

(30) Foreign Application Priority Data
Oct. 4, 2011 (JP) 2011-219747

(51) Int. Cl. G09G 5/00

(52) U.S. Cl. 345/204

(57) ABSTRACT

A content display apparatus comprises a display unit which displays a content which has a plurality of characters an order of which is regulated, a position directions unit which directs a position on the display unit, and a control unit which controls a display on the display unit, according to the position directed by the position directions unit and the order of the characters. At a first operation mode, when the position directions unit directs a first position on the display unit, the control unit makes the characters corresponding to the directed first position impossible to be viewed on the display unit. At a second operation mode, when the position directions unit directs a second position on the display unit, the control unit makes such characters possible to be viewed that were made impossible to be viewed and that are located before the directed second position under the order.

### CROSS-REFERENCE TO RELATED APPLICATIONS

This application is a continuation application of PCT International Patent Application No. PCT/JP2011/007276 filed Dec. 26, 2011, claiming the benefit of priorities of Japanese Patent Application No. 2011-219747 filed Oct. 4, 2011, all of which are incorporated by reference herein in their entirety.

### BACKGROUND OF THE INVENTION

1. Field of the Invention

The present invention relates to a content display apparatus, a content display method and the like. For example, the present invention relates to a content display apparatus, a content display method and the like of displaying an electronic book.

2. Related Art of the Invention

Conventionally, by coloring red the part to be memorized, of a document of black printing, seeing the part through a transparent blue or green check sheet of complementary color and coloring pitch-dark the part to be memorized, a simple study implement which aims at improvement of the study efficiency of memorization is known (see for example Japanese Patent Application Laid-Open No. S56-035164).

FIG. 24(A) shows a diagram of the colored part to be memorized, of the conventional physical document. FIG. 24(B) shows a plan view of a check sheet. FIG. 24(C) is a diagram showing a state of the view when the check sheet 202 is put on the document 200 shown in FIG. 24(A) and the document 200 is seen through.

First, the part to be memorized, of the document 200 of black printing is colored by red ink as shown in FIG. 24(A). In FIG. 24(A), the part colored by red ink is shown with half-tone dot meshing as a specific zone 201.

When the transparent check sheet 202 made from a plastic material colored uniformly with blue or green, which is complementary color of red, as shown in FIG. 24(B), is put on the document 200 the specific zone 201 of which is colored red as shown in FIG. 24(A) and the document 200 is seen through, the specific zone 201 becomes pitch-dark and distinction of the contents of printing of the specific zone 201 of the overlapping portion becomes invisible. On the other hand, the residual display portion is tinged with the ground color of the sheet, and can be viewed distinctly. In FIG. 24(C), the pitch-dark portion among the specific zone 201 is shown with black color section.

Therefore, only by putting the check sheet 202 on the document 200, the required portion can be concealed virtually.

A combination of the green ink and the red check sheet is known other than the combination of the red ink and the blue or green check sheet.

In this way, by the study method using the study implement described in the Japanese Patent Application Laid-Open No. S56-035164, the portion to be memorized, of a book at hand such as a textbook is colored by ink and a collection of problems can be easily created. The study method is useful to memorization and is a method generally used widely, because the character under the portion colored by ink can be read when not seeing it through the check sheet 202.

However, efficient study using the conventional check sheet cannot be performed at an electric book terminal or the like which displays electronic books.

In recent years, along with currency of digitization, the conversion of books to the electronic form by a small terminal, is in common currency. It is what is called an electronic book. Since the performance of the terminal is improving, the terminal can be equipped with a color liquid crystal display with a touch panel, books can be displayed on a screen and can be read. Intuitive operation such as a page turning by a flick operation to the touch panel, a scaling by a pinch operation to the touch panel or the like can be realized now.

The red pen and the check sheet in the study implement described in the Japanese Patent Application Laid-Open No. S56-035164 are physical things, and these cannot be utilized for an electronic book. In many cases, the electronic book has a structure in which a page of the book is displayed on one liquid crystal display at any time based on user operation. When a line is drawn with the red pen on the liquid crystal display while a specific page is being displayed, the markers drawn by the red pen remain even if another page is displayed on the liquid crystal display, and this is meaningless.

Regarding the study implement described in the Japanese Patent Application Laid-Open No. S56-035164, according to the composition of sentences printed on the document, the answer might be accidentally seen earlier during study.

Regarding the study implement described in the Japanese Patent Application Laid-Open No. S56-035164, display or non-display of the specific zone 201 is dependent on the shape of the check sheet 202. In other words, when the check sheet 202 of about the same size as the approximately rectangular physical document 200 as shown in FIG. 24(B) is used, the study is continued by making the check sheet 202 slide downward from the top of the document 200 for horizontal writing.

FIG. 25(A) shows a diagram of the colored part to be memorized of the document 200, the sentences being printed with the composition of two columns by horizontal writing. FIG. 25(B) is a diagram showing a state of the view when the check sheet 202 is put on the document 200 and the document 200 is seen through.

When the check sheet 202 put on the document 200 is slid downward from the top, as shown in FIG. 25(B), the characters on a portion of the specific zone 201 with which the check sheet 202 does not overlap, can be viewed. When continuing study of the portion printed in the column on the left-hand side of the two columns, as shown FIG. 25(B), the portion above the check sheet 202 of the column of the left-hand side of the specific zone 201 can be viewed. At this time, regarding the column of the right-hand side of the specific zone 201, the portion above the check sheet 202 also can be viewed.

The sentences of the column on the right-hand side of the two columns is a portion to be learned after learning the sentences of the left-hand side column. While learning the left-hand side column, the answer of the portion to be learned next is viewed.

In view of the above-mentioned problems, an object of the present invention is to provide a content display apparatus, a content display method and the like such that the portion for which a concealment state is expected is not accidentally viewed and efficient study can be performed.

### SUMMARY OF THE INVENTION

The 1^{st} aspect of the present invention is a content display apparatus comprising:

a display unit which displays a content including at least a character string content which has a plurality of characters an order of which is regulated;

a position directions unit which directs a position on the display unit; and

a control unit which controls a display on the display unit, according to the position directed by the position directions unit and the order of the characters; wherein

at a first operation mode, when the position directions unit directs a first position on the display unit, the control unit makes the characters corresponding to the directed first position impossible to be viewed on the display unit; and

at a second operation mode, when the position directions unit directs a second position on the display unit, the control unit makes such characters possible to be viewed that were made impossible to be viewed and that are located before the directed second position under the order.

The 2^{nd} aspect of the present invention is the content display apparatus according to the 1^{st} aspect of the present invention, wherein

the content includes another content which is displayed on another display area other than a display area for the character string content and an order of the another content to the plurality of the characters is regulated;

the control unit controls the display on the display unit, according to the position directed by the position directions unit and the order of the characters and the order of the another content;

at the first operation mode, when the position directions unit directs the first position on the display unit, the control unit makes the characters or the another content corresponding to the directed first position impossible to be viewed on the display unit; and

at the second operation mode, when the position directions unit directs the second position on the display unit, the control unit makes such characters or the another content possible to be viewed that were or was made impossible to be viewed and that are or is located before the directed second position under the order of the characters and the order of the another content.

The 3^{rd} aspect of the present invention is the content display apparatus according to the 2^{nd} aspect of the present invention, wherein

when the character string includes a term which indicates the another content, the order of the another content is regulated according to an order of the term among the characters.

The 4^{th} aspect of the present invention is the content display apparatus according to the 2^{nd} aspect of the present invention, comprising another content order determination unit, wherein

when characters are included in the another content, the another content order determination unit determines an order of the characters in the another content displayed on the display unit, according to a displayed position of the characters in the another content and a layout information of the displayed another content.

The 5^{th} aspect of the present invention is the content display apparatus according to the 1^{st} aspect of the present invention, further comprising a character recognition unit and an order determination unit, wherein

when the character string content is image data, the character recognition unit recognizes a character in the character string content; and

when the content is displayed on the display unit, the order determination unit determines an order of the characters displayed on the display unit, according to a displayed position of the characters on the display unit, recognized by the character recognition unit and a layout information of the displayed content.

The 6^{th} aspect of the present invention is the content display apparatus according to the 5^{th} aspect of the present invention, wherein

the order determination unit determines the order of the characters displayed on the display unit, according to a meaning of a sentence of the characters, in addition to the displayed position of the characters on the display unit and the layout information.

The 7^{th} aspect of the present invention is the content display apparatus according to the 1^{st} aspect of the present invention, further comprising

an operation mode change unit which changes the first operation mode and the second operation mode according to an instruction from a user.

The 8^{th} aspect of the present invention is the content display apparatus according to the 1^{st} aspect of the present invention, wherein

the control unit makes the character corresponding to the directed first position impossible to be viewed, by displaying a marker on the character corresponding to the first position directed by the position directions unit.

The 9^{th} aspect of the present invention is the content display apparatus according to the 8^{th} aspect of the present invention, further comprising an display mode change unit, wherein

the display mode change unit can change the displayed marker in such a manner that the display mode change unit exchanges a first state in which the marker is not displayed, a second state in which the marker is displayed with semitransparent appearance so that the character corresponding to the directed first position can be viewed and a third state in which the marker is displayed so that the character corresponding to the directed first position cannot be viewed.

The 10^{th} aspect of the present invention is a content display method comprising:

a display step of displaying a content including at least a character string content which has a plurality of characters an order of which is regulated, on a display unit;

a position directions step of directing a position on the display unit;

a first operation step of making the characters corresponding to a first position directed by the position directions step impossible to be viewed on the display unit; and

a second operation step of making such characters possible to be viewed that were made impossible to be viewed and that are located before a second position directed by the position directions step under the order.

The 11^{th} aspect of the present invention is a non-transitory computer-readable medium having a program stored thereon, wherein the program causes a computer to execute the content display method according to the 10^{th} aspect of the present invention.

The present invention can provide a content display apparatus, a content display method and the like such that the portion for which a concealment state is expected is not accidentally viewed and efficient study can be performed.

### BRIEF DESCRIPTION OF THE DRAWINGS

FIG. 1 is a block diagram showing a configuration of an electronic book terminal for study according to a first embodiment of the present invention;

FIG. 2 is a diagram showing a relation of an operation mode transition of the electronic book terminal for study according to the first embodiment of the present invention;

FIG. 3 is a diagram showing a flow of operation at a time of a reading mode of the electronic book terminal for study according to the first embodiment of the present invention;

FIG. 4 is a diagram showing an example of a display of a screen at a time of the reading mode of the electronic book terminal for study according to the first embodiment of the present invention;

FIG. 5 is a block diagram showing the electronic book terminal for study at a time of an entry mode according to the first embodiment of the present invention;

FIG. 6 is a diagram showing a flow of operation at a time of the entry mode and at a time of a learning mode of the electronic book terminal for study according to the first embodiment of the present invention;

FIG. 7 is a diagram showing a flow of operation of a judgment processing of a character in a position touched by a user in a character position judgment unit according to the first embodiment of the present invention;

FIG. 8(A) is a diagram showing a document of an electronic book content stored in an electronic book document temporary store unit according to the first embodiment of the present invention;

FIG. 8(B) is a diagram showing a layer stored in a layer temporary store unit according to the first embodiment of the present invention;

FIG. 8(C) is a diagram showing a picture of combination obtained by a screen combination unit according to the first embodiment of the present invention;

FIG. 9(A) is a diagram showing the electronic book terminal for study before the user touches an input device at a time of the entry mode according to the first embodiment of the present invention;

FIG. 9(B) is a diagram showing a state in which the user's finger touches a part of the document displayed on a display device at a time of the entry mode according to the first embodiment of the present invention;

FIG. 9(C) is a diagram showing a state in which the user's finger moves to the right when the user's finger touches the screen of the display device at a time of the entry mode according to the first embodiment of the present invention;

FIG. 9(D) is a diagram showing a state in which the user's finger is detached from the display device after the user's finger further moves to the right when the user's finger touches the screen of the display device at a time of the entry mode according to the first embodiment of the present invention;

FIG. 10 is a diagram showing an example of a display when a plurality of markers is filled in at a time of the entry mode of the electronic book terminal for study according to the first embodiment of the present invention;

FIG. 11 is a block diagram showing the electronic book terminal for study at a time of the learning mode according to the first embodiment of the present invention;

FIG. 12 is a diagram showing a flow of operation of a judgment processing of picking up only the information on the predetermined markers, positions of which are below the position the user touches, in a layer control unit according to the first embodiment of the present invention;

FIG. 13(A) is a diagram showing a document of an electronic book content stored in the electronic book document temporary store unit according to the first embodiment of the present invention;

FIG. 13(B) is a diagram showing a layer stored in the layer temporary store unit according to the first embodiment of the present invention;

FIG. 13(C) is a diagram showing a picture of combination obtained by the screen combination unit according to the first embodiment of the present invention;

FIG. 14(A) is a diagram showing the electronic book terminal for study before the user touches the input device at a time of the learning mode according to the first embodiment of the present invention;

FIG. 14(B) is a diagram showing a state in which the user's finger touches a part of the document displayed on the display device at a time of the learning mode according to the first embodiment of the present invention;

FIG. 14(C) is a diagram showing a state in which the user's finger slides to the bottom when the user's finger touches the screen of the display device at a time of the learning mode according to the first embodiment of the present invention;

FIG. 14(D) is a diagram showing a state in which the user's finger touches the middle of the column on the right-hand side of the sentences composed with two columns at a time of the learning mode according to the first embodiment of the present invention;

FIG. 14(E) is a diagram showing a state in which the user's finger is detached from the display device at a time of the learning mode according to the first embodiment of the present invention;

FIG. 15 is a diagram showing areas where the marker is displayed or the marker is not displayed, when sentences by vertical writing is displayed on the electronic book terminal for study at a time of the learning mode according to the first embodiment of the present invention;

FIG. 16 is a block diagram showing a configuration of an electronic book terminal for study according to a second embodiment of the present invention;

FIG. 17(A) is a diagram showing a document of an electronic book content stored in an electronic book document temporary store unit according to the second embodiment of the present invention;

FIG. 17(B) is a diagram showing a layer stored in a layer temporary store unit according to the second embodiment of the present invention;

FIG. 17(C) is a diagram showing a picture of combination obtained by a screen combination unit according to the second embodiment of the present invention;

FIG. 18(A) is a diagram showing the electronic book terminal for study before the user touches an input device at a time of the learning mode according to the second embodiment of the present invention;

FIG. 18(B) is a diagram showing a state in which the user's finger touches a part of the document displayed on a display device at a time of the learning mode according to the second embodiment of the present invention;

FIG. 18(C) is a diagram showing a state in which the user's finger slides to the bottom when the user's finger touches the screen of the display device at a time of the learning mode according to the second embodiment of the present invention;

FIG. 18(D) is a diagram showing a state in which the user's finger touches the middle of the column on the right-hand side of the sentences composed with two columns at a time of the learning mode according to the second embodiment of the present invention;

FIG. 18(E) is a diagram showing a state in which the user's finger is detached from the display device at a time of the learning mode according to the second embodiment of the present invention;

FIG. 19 is a block diagram showing a configuration of another electronic book terminal for study according to the second embodiment of the present invention;

FIG. 20 is a diagram showing an example of a display of a screen at a time of the reading mode of the electronic book terminal for study according to the second embodiment of the present invention;

FIG. 21(A) is a diagram showing the electronic book terminal for study before the user touches the input device at a time of the learning mode according to another second embodiment of the present invention;

FIG. 21(B) is a diagram showing a state in which the user's finger touches a part of the document displayed on the display device at a time of the learning mode according to another second embodiment of the present invention;

FIG. 21(C) is a diagram showing a state in which the user's finger slides to the bottom when the user's finger touches the screen of the display device at a time of the learning mode according to another second embodiment of the present invention;

FIG. 21(D) is a diagram showing a state in which the user's finger touches the middle of the column on the right-hand side of the sentences composed with two columns at a time of the learning mode according to another second embodiment of the present invention;

FIG. 21(E) is a diagram showing a state in which the user's finger is detached from the display device at a time of the learning mode according to another second embodiment of the present invention;

FIG. 22 is a block diagram showing a configuration of an electronic book terminal for study according to a third embodiment of the present invention;

FIG. 23 is a diagram showing an example of a display of a screen at a time of the reading mode of the electronic book terminal for study according to the third embodiment of the present invention;

FIG. 24(A) is a diagram showing a conventional physical document whose part to be memorized is colored;

FIG. 24(B) is a plan view of a conventional check sheet;

FIG. 24(C) is a diagram showing a state of a view when the check sheet is put on the conventional physical document and the document is seen through;

FIG. 25(A) is a diagram showing a conventional document such that the sentences are printed with a composition of two columns and a part of the document to be memorized is colored; and

FIG. 25(B) is a diagram showing a state of a view when the check sheet is put on the conventional document such that the sentences are printed with the composition of two columns and the part to be memorized is colored, and the document is seen through.

### DESCRIPTION OF SYMBOLS

100 Electronic book terminal for study
101 Input device
102 Input position detecting unit
103 Operation mode change unit
104 Operation mode judgment unit
105 Marker information store unit
106 Electronic book store unit
107 Character position judgment unit
108 Layer control unit
109 Layer temporary store unit
110 Electronic book parser unit
111 Screen combination unit
112 Display device
113 Electronic book document temporary store unit
120 Document
121 Sentences
122 Illustration
123, 126 Layer
124, 127 Marker
125, 128 Combined picture
130 Document
131 Sentences
132 Image data
133 Term which indicates a drawing
134 Character string which agrees with the term showing a drawing
136 Layer
137 Area marker
138 Combined picture
140 Document
141, 142, 143, 144 Character group
145 Image which cannot carry out character recognition
150 Electronic book terminal for study
154 Character recognition processing unit
155 Marker information store unit
157 Content position judgment unit
158 Layer control unit
160 Electronic book terminal for study
167 Content position judgment unit
170 Electronic book terminal for study
174 Character recognition processing unit
175 Marker information store unit
177 Character position judgment unit
178 Layer control unit
401, 402, 403 State
801, 1301, 1401 User's finger
802, 1302-1309 Marker
1402 Flow direction of sentences
1403 Marker display area
1404 Marker non-display area
200 Document
201 Specific zone
202 Check sheet

### PREFERRED EMBODIMENTS OF THE INVENTION

Electronic book terminals for study according to embodiments to which the present invention is applied are described in detail below with reference to the drawings.

### First Embodiment

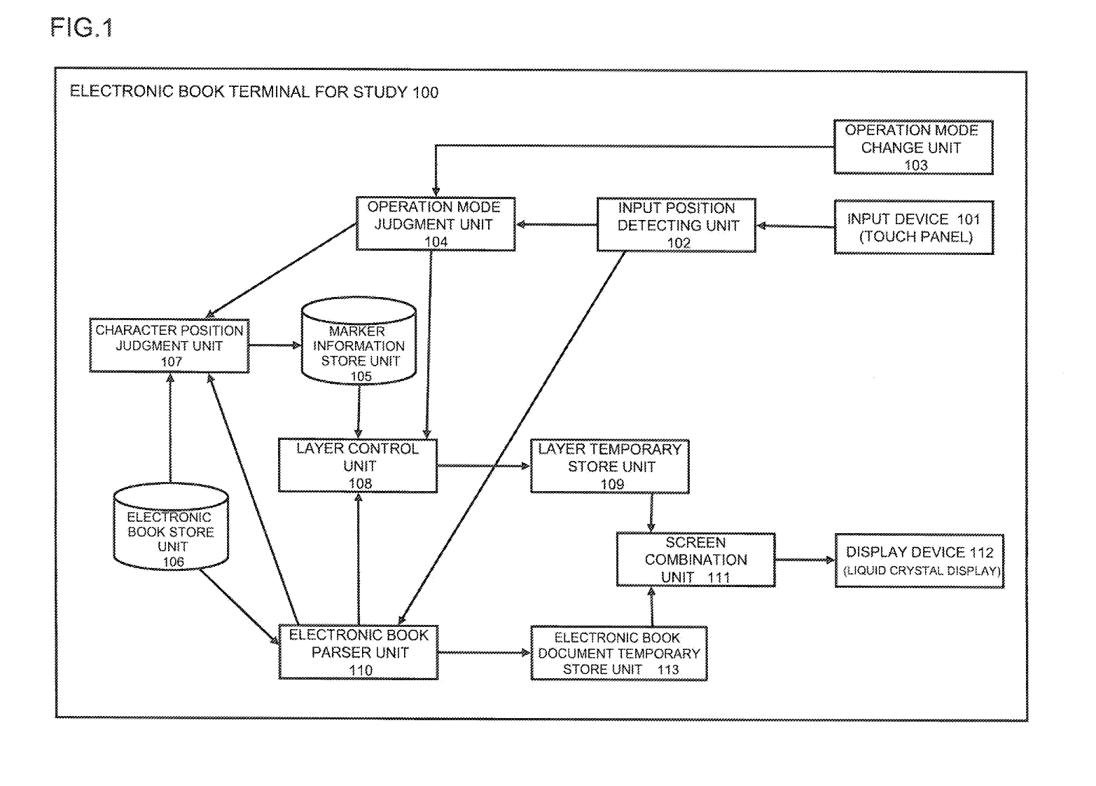

FIG. 1(A) is a block diagram of an electronic book terminal for study according to a first embodiment of the present invention.

As shown in FIG. 1, the electronic book terminal for study 100 according to the first embodiment comprises an input device 101, an input position detecting unit 102, an operation mode change unit 103, an operation mode judgment unit 104, a marker information store unit 105, an electronic book store unit 106, a character position judgment unit 107, a layer control unit 108, a layer temporary store unit 109, an electronic book parser unit 110, a screen combination unit 111, a display device (e.g. a liquid crystal display) 112 and an electronic book document temporary store unit 113.

The electronic book terminal for study 100 corresponds to an example of a content display apparatus according to the present invention. The input device 101 corresponds to an example of a position directions unit according to the present invention. The display device 112 corresponds to an example of a display unit according to the present invention. The layer control unit 108 corresponds to an example of a control unit according to the present invention.

The electronic book store unit 106 stores data of an electronic book content which can be read by the electronic book terminal for study 100. The electronic book store unit 106 is a nonvolatile memory. In fact, the electronic book store unit 106 can be a flash memory or a hard disk built in the body of the electronic book terminal for study 100, or an exchangeable recording medium. When an electronic book terminal can use a network, electronic book contents are stored in a recording area in a server and the electronic book terminal may acquire the electronic book contents through the network when the electronic book terminal needs the contents. In this case, the electronic book store unit 106 doesn't exist in the electronic book terminal for study 100 and exists in the external server. Since it is only a difference of mere composition, this is not illustrated anew.

There are different formats of the data of electronic book contents which are stored in the electronic book store unit 106. For example, there is a content including character code data, or there is a content all the data of which is image data.

The electronic book content including character code data corresponds to an example of a content including at least a character string content according to the present invention. The electronic book content not including character code data also corresponds to an example of a content including at least a character string content according to the present invention.

In the first embodiment, a case of the electronic book content including character code data is described.

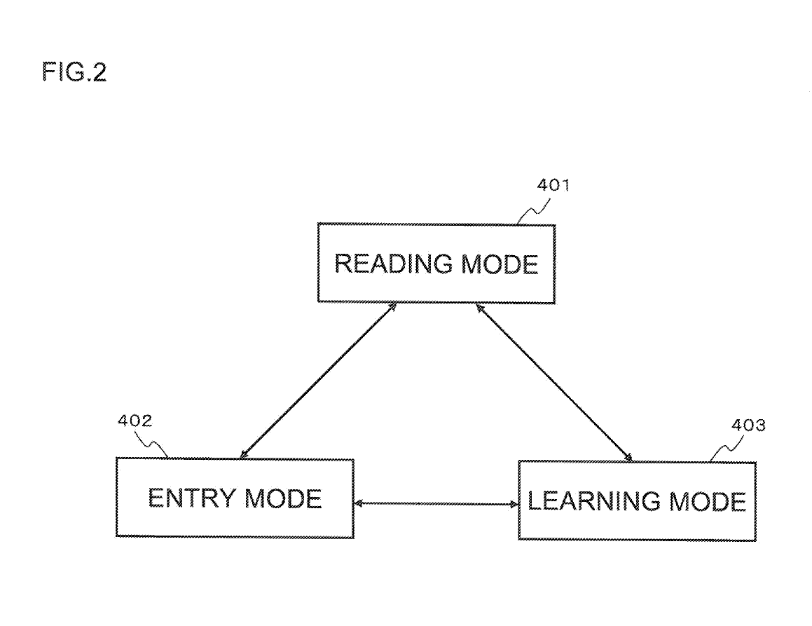

In the first embodiment, a usual state of reading the electronic book is defined as a “reading mode”. The electronic book terminal for study 100 has an entry mode and a learning mode other than the reading mode. The electronic book terminal for study 100 has these three modes in total. FIG. 2 shows a diagram of a relation of transition of these three operation modes.

The reading mode (a state 401), the entry mode (a state 402), and the learning mode (a state 403) can be mutually exchanged by user's indications. The user's indications are detected by the operation mode change unit 103. The operation mode change unit 103 urges the user to select any one of the reading mode (the state 401), the entry mode (the state 402) and the learning mode (the state 403).

The operation mode change unit 103 can be a switch or a sensor attached to the body of the electronic book terminal for study 100 as hardware. The display device 112 can display a menu or icons, and user's indications can be accepted from the input device 101 by software. In this case, the operation mode change unit 103 unites with the input device 101. Operations from an external controller or a remote controller can be accepted, or indications by user's voice using a microphone can be received. The operational mode change unit 103 may have any composition. Anyhow, the electronic book terminal for study 100 is equipped with required functions according to the acceptance method of user's indications. In the first embodiment it will be generically called the operation mode change unit 103.

When the operation mode change unit 103 changes the reading mode (the state 401) to the entry mode (the state 402) or the learning mode (the state 403), the electronic book terminal for study 100 performs special operations of the first embodiment shown below.

The entry mode corresponds to an example of a first operation mode according to the present invention. The learning mode corresponds to an example of a second operation mode according to the present invention. The operation mode change unit 103 corresponds to an example of an operation mode change unit according to the present invention.

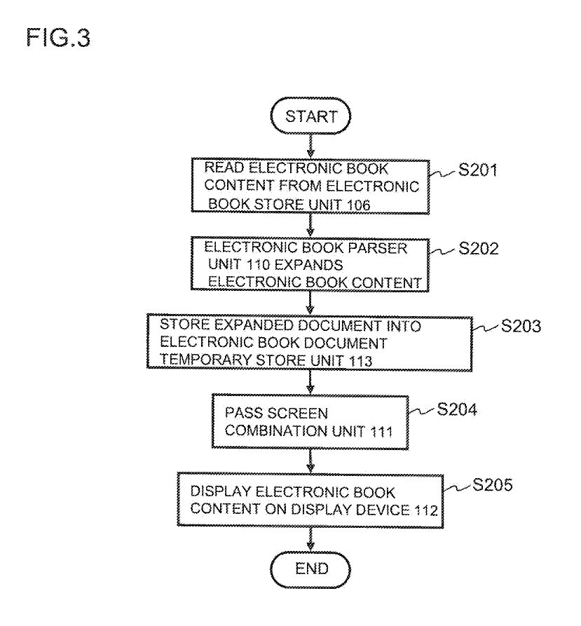

First, a procedure in the reading mode, which is a usual state where the electronic book content is read before study at the electronic book terminal for study 100, is described referring to FIG. 1 and FIG. 3.

FIG. 3 shows a flow of operation at a time of the reading mode of the electronic book terminal for study 100 according to the first embodiment.

The term “electronic book content” is used in this specification. In this specification, the term “book” is used as a broad concept, which also includes a magazine in addition to general books.

The user refers to a menu or the like which is displayed on the display device 112, and selects an electronic book using the input device 101. The input position detecting unit 102 processes a user's operation inputted by the input device 101 as input information, and notifies it to the electronic book parser unit 110.

The electronic book parser unit 110 reads out the electronic book content selected by the user from the electronic book store unit 106 (step S201 in FIG. 3). The electronic book parser unit 110 expands the electronic book content, and creates a document (step S202). The electronic book parser unit 110 also performs release of DRM applied to the electronic book content. Thereby, a screen of the electronic book including a layout equivalent to the pages of the books of paper can be created. In this specification, the screen is expressed as a “document.” The “document” in this specification does not necessarily mean “writing”. The “document” in this specification means an “image” actually displayed on the display device 112.

The document of the electronic book content created by the electronic book parser unit 110 is stored in the electronic book document temporary store unit 113 (step S203). A volatile memory built in the electronic book terminal for study 100 is assumed to be the electronic book document temporary store unit 113. When a GPU (Graphics Processing Unit) is loaded, the electronic book document temporary store unit 113 can be a memory area managed by the GPU. In the first embodiment, a temporary memory is assumed to be the electronic book document temporary store unit 113. By restriction of hardware or the like, a nonvolatile memory such as a flash memory can be used as the electronic book document temporary store unit 113.

The document stored in the electronic book document temporary store unit 113 is transmitted to the screen combination unit 111 and is combined with the other layer (step S204).

Primarily, the screen combination unit 111 is a block aiming at combining and displaying a picture, which should be on the document of the electronic book content, and the document. A virtual layer, in which the picture to be combined with the document is specified, is called a “layer”. Such a “layer” is described later. In the explanation using FIG. 1 and FIG. 3, a transparent layer and a document of the electronic book content are combined and outputted to the display device 112 or, alternatively, the layer is not combined with the document and only the document of the electronic book content is outputted to the display device 112.

The document (the picture combined with the transparent layer) which has passed the screen combination unit 111 is transmitted and displayed on the display device 112 (step S205). A liquid crystal display device which the electronic book terminal for study 100 has is assumed to be the display device 112. An organic electroluminescence display device or an external display device can be used as the display device 112, because it is only required to have a function of displaying a page of the book.

The input device 101 is a device for inputting user operation into the electronic book terminal for study 100. The spread of tablet type personal computers in recent years often allows the electronic book terminal to be equipped with a liquid crystal display device with a touch panel on its surface, and realizes an operation by touching a screen. Therefore, the touch panel is assumed to be the input device 101 in the first embodiment unless otherwise stated. The touch panel is united with the display device 112.

The input device 101 can be a mouse displayed on the screen, and such a mouse may be used like one for a conventional personal computer. The combination of the cursor displayed on the screen and any one of a keyboard, a controller used for a game, a remote control device and the like, also can be used as the input device 101.

In a state where step S203 in FIG. 3 has been completed, the electronic book terminal for study 100 displays a specific page of the electronic book content stored in the electronic book store unit 106, on the display device 112, as the document.

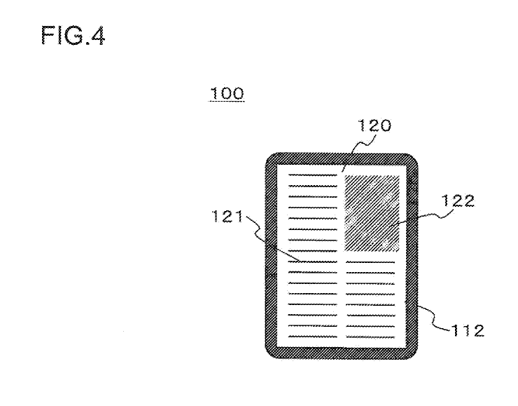

An example of the display is shown in FIG. 4. FIG. 4 shows a state where a document 120 of the electronic book content is displayed on the display device 112 of the electronic book terminal for study 100.

In the first embodiment, one page of the document is displayed on one screen of the display device 112. The document 120 displayed on the display device 112 shown in FIG. 4 has sentences 121 with a composition of two columns by horizontal writing, and an illustration 122 is inserted in the upper right. This is only an example, and in fact the sentences can be one by vertical writing. The existence of column setting, the number of the column settings, the existence of the illustration and the number of the illustration are arbitrary. A plurality of pages of the electronic book content can be displayed on the display device 112. One document can be created by a plurality of pages, or a plurality of documents of an independent page can be displayed collectively. A part of the document can be enlarged and displayed.

In the state shown in FIG. 4, the user can read the electronic book. A description about this is omitted in the first embodiment.

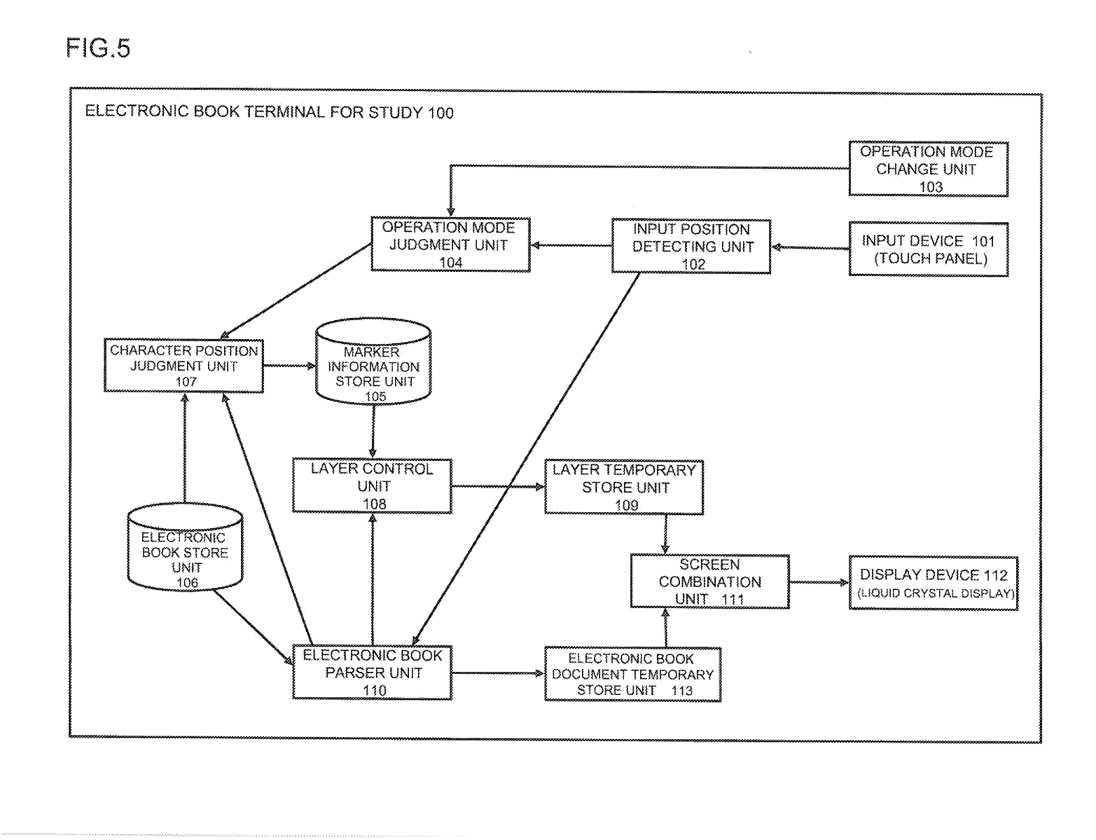

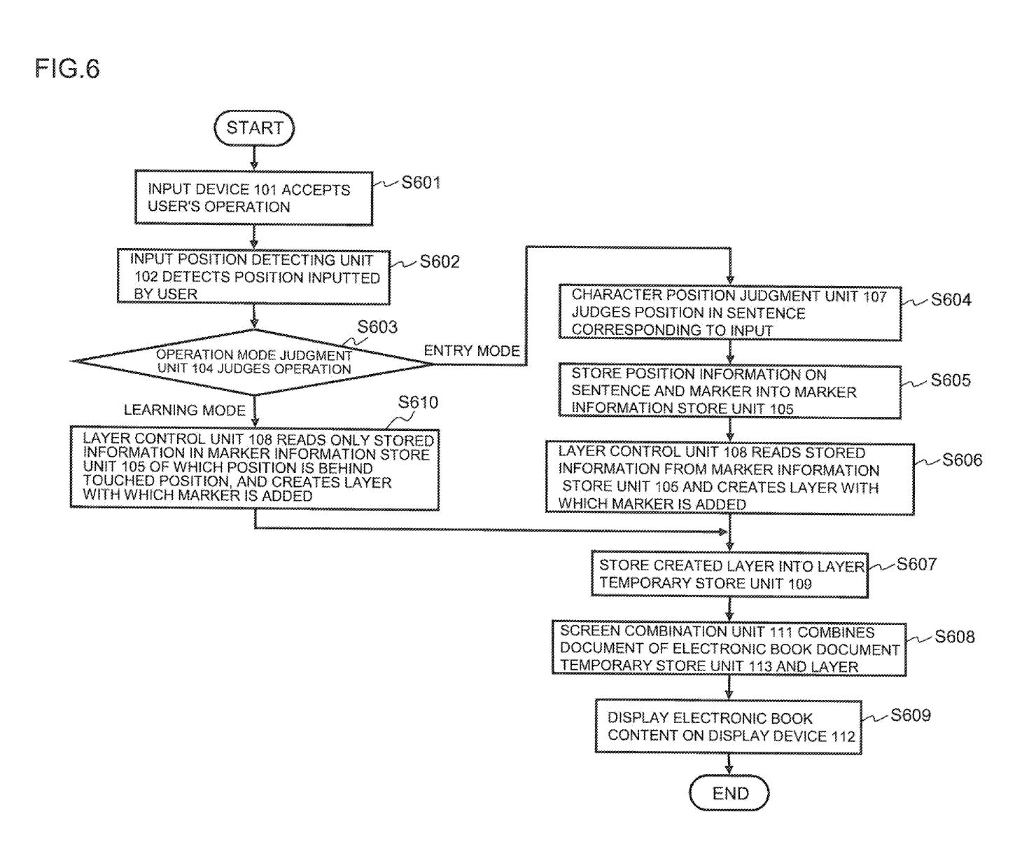

When the mode is changed to the entry mode (the state 402) by the user operation to the operation mode change unit 103, the operation of the electronic book terminal for study 100 is described using FIG. 5 and FIG. 6.

With regard to the block diagram of the electronic book terminal for study 100 in FIG. 1, the operation in the entry mode (the state 402) is shown in the block diagram in FIG. 5.

FIG. 6 shows a flow of operation at a time of the entry mode and at a time of the learning mode of the electronic book terminal for study 100 according to the first embodiment.

The entry mode (the state 402) corresponds to the operation which colors the document by red ink in Japanese Patent Application Laid-Open No. S56-035164. By coloring the place where the user wants to memorize a textbook or the like by red ink, the place is hidden when a green check sheet is put on it. The entry mode is, so to speak, a preparatory step before study.

It is meaningless to color the display device 112 itself by using the red ink as described in Japanese Patent Application Laid-Open No. S56-035164. Therefore, a function similar to this is realized by a function of the electronic book terminal for study 100.

Also in the entry mode (the state 402), the document 120 of the electronic book content is displayed on the display device 112 by the processes of steps S201 to S203 in FIG. 3. A marker is drawn when the user touches the place of characters to be memorized for study, and the user can perform an operation to hide a part of the document of the electronic book content. The input device 101 accepts the user's operation (step S601 in FIG. 6).

The user's operation inputted by the input device 101 is processed by the input position detecting unit 102 as input information. The input position detecting unit 102 digitizes and acquires the position touched by the user (step S602). The input position detecting unit 102 is implemented as hardware as a controller of the input device 101 in many cases, the numerical value according to the position touched by the user is processed as input information on OS level in the electronic book terminal for study 100.

The input position detecting unit 102 notifies, to the operation mode judgment unit 104, that there is an input from the user. The operation mode judgment unit 104 records the present operation mode changed by the operation mode change unit 103. The operation mode judgment unit 104 judges a subsequent operation, according to the present operation mode recorded (step S603). Here, for description, the present operation mode is being limited to the entry mode (the state 402). The learning mode (the state 403) is described later.

When the present operation mode is the entry mode (the state 402), the character position judgment unit 107 judges the position on sentences corresponding to the position touched by the user (step S604).

The information of the sentences 121 contained in the document 120 currently displayed on the display device 112 is required for this judgment. Therefore, the character position judgment unit 107 receives the information (hereafter, called “document information”) about the document 120 of the electronic book content currently displayed on the display device 112 from the electronic book parser unit 110. The character position judgment unit 107 examines which character the user touched from the document information and information on the display position detected by the input position detecting unit 102.

At this time, the character position judgment unit 107 acquires order information on sentences according to the character judged to have been touched by the user. The character position judgment unit 107 can acquire, from the electronic book store unit 106, the order in the electronic book content, according to the position of the code data of the character judged to have been touched in the relevant electronic book content.

When the electronic book terminal for study 100 has a function of displaying a plurality of pages in one screen on the display device 112, or when the electronic book terminal for study 100 has a scaling function for the document, information on what is displayed on which position is required as well. In these cases, the character position judgment unit 107 acquires the information from the electronic book parser unit 110 as the document information.

An example of the judgment method concerning the character in the position touched by the user in the character position judgment unit 107 is described.

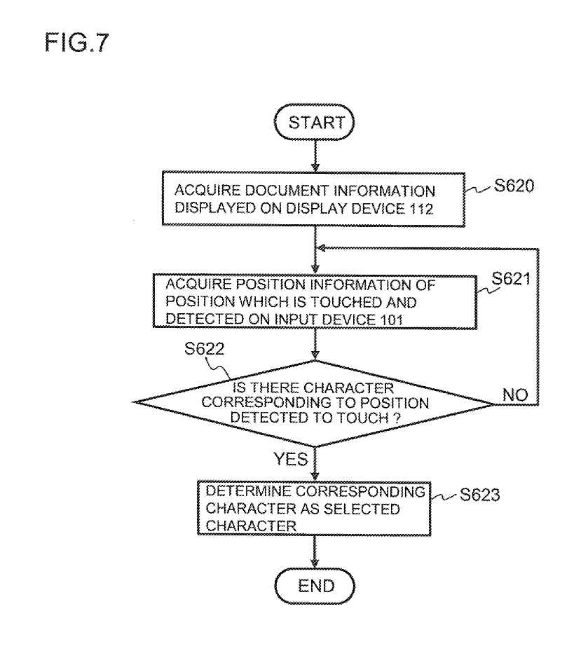

FIG. 7 shows a flow of operation of the judgment processing (step S604) of the character in the position touched by the user in the character position judgment unit 107.

The character position judgment unit 107 acquires the document information of the electronic book content currently displayed on the display device 112 from the electronic book parser unit 110 (step S620). And the character position judgment unit 107 also acquires the position information of the position which has been touched by user on the input device 101 and detected by the input position detecting unit 102 (step S621).

The character position judgment unit 107 refers to the document information acquired from the electronic book parser unit 110, and judges whether there is a character corresponding to the position touched by the user in the input device 101 (step S622).

For example, it is judged whether there is, among the characters displayed on the display device 112, a character at a part of a display area which overlaps with a circular area of a predetermined size centered at the position touched by the user. When there is a character at the part of the display area which overlaps with the circular area, the character is judged to be a character corresponding to the position touched by the user. When there is no character at the part of the display area which overlaps with the circular area, it is judged that there is no character corresponding to the position touched by the user.

Therefore, when a neighborhood of the character displayed on the display device 112 is touched, the character is judged to be the character touched by the user. But, when the user touches a space position between the lines for which characters are not displayed on the display device 112, it is judged that there is no character corresponding to the position touched by the user.

When it is judged that there is no character corresponding to the position touched by the user, processing of steps S621 and S622 are performed repeatedly. And, when there is a character corresponding to the position touched by the user, it is decided that the character should be the character corresponding to the position touched by the user (step S623).

The character which is judged to be the character corresponding to the position touched by the user in step S622 by the character position judgment unit 107 corresponds to an example of characters corresponding to a first position directed in a first mode according to the present invention.

Returning to FIG. 6, further description is provided. The information of the position touched by the user is changed into the position information on the document by the character position judgment unit 107, and is stored in the marker information store unit 105 as marker information (step S605). At this time, the character position judgment unit 107 also stores, into the marker information store unit 105, the order information on the electronic book content of the character of the position touched by the user. The order information, which is then stored, is based on the character code data of the character string included in the electronic book content. Therefore, the order information shows an order in accordance with the context of the sentences (i.e., flow direction of the sentences).

Since there can be a case where two or more electronic book contents exist, it is necessary to clarify about which electronic book content the marker information is. The information that shows with which electronic book content the marker information is concerned is also recorded in the marker information store unit 105. In order to make easy management in the electronic book store unit 106, when unique IDs are used for electronic book contents, it is good to utilize such IDs.

Among the marker information stored in the marker information store unit 105, only the marker information about the document of the electronic book content that was displayed when the user touched the input device 101 is transmitted to the layer control unit 108.

The layer control unit 108 writes a marker in a layer using the received marker information. This layer is a layer for drawing on the document of the electronic book content displayed on the display device 112. The layer control unit 108 creates the layer of one sheet from two or more pieces of marker information (step S606).

When the electronic book terminal for study 100 has the function of displaying a plurality of pages in one screen on the display device 112, or when the electronic book terminal for study 100 has the scaling function for the document, the layer has to be created also in consideration of the displaying position of a plurality of pages or the position of the resized document.

The created layer is stored in the layer temporary store unit 109 (step S607).

The screen combination unit 111 combines (a) the document of the electronic book content which has been expanded by the electronic book parser unit 110 and is stored in the electronic document temporary store unit 113, and (b) the layer stored in the layer temporary store unit 109 (step S608). The document which has been expanded by the electronic book parser unit 110 and is stored in the electronic document temporary store unit 113 is the same document 120 as what was stored before the user touches the input device 101.

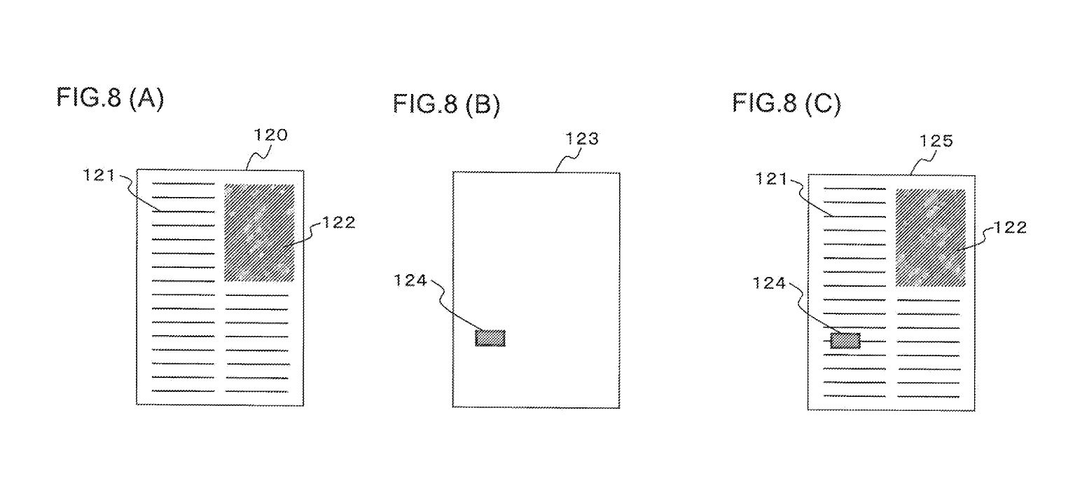

The combination performed by the screen combination unit 111 of (a) the document of the electronic book content which has been expanded by the electronic book parser unit 110 and is stored in the electronic document temporary store unit 113, and (b) the layer stored in the layer temporary store unit 109 is described using FIGS. 8(A) to 8(C).

FIG. 8(A) is a diagram showing the document 120 of the electronic book content stored in the electronic book document temporary store unit 113. The diagram shown in FIG. 8(A) has the same description as the screen which is displayed on the display device 112 of the electronic book terminal for study 100 shown in FIG. 4.

FIG. 8(B) is a diagram showing the layer 123 stored in the layer temporary store unit 109. The marker 124 for hiding a part of the sentences 121 is described. The other portion of the layer 123 is of transparent color, at the time of the combination, the layer 123 is put on the document 120 of the electronic book content and the marker 124 is displayed.

FIG. 8(C) is a diagram showing a picture 125 obtained through combination by the screen combination unit 111. The picture 125 is a picture obtained through combination of the document 120 of the electronic book content shown in FIG. 8(A) and the layer 123 shown in FIG. 8(B). The marker 124 is displayed over the document 120 of the electronic book content. A part of the document 120 of the electronic book content is hidden by this. Therefore, the document 120 of the electronic book content must be located under the layer 123 in the combination. The screen combination unit 111 processes this combination.

Returning to FIG. 6, further description is provided. The picture 125 obtained through combination by the screen combination unit 111 is displayed on the display device 112 (step S609).

Thereby, a state can be created such that the markers are drawn on the book by red ink and the relevant portion cannot be viewed with the check sheet, as described in Japanese Patent Application Laid-Open No. S56-035164.

The operation of making the character string nonreadable, which is included in the document 120 of the portion overlapping with the marker 124, corresponds to an example of an operation of making characters corresponding to a directed first position impossible to be viewed at a first operation mode according to the present invention.

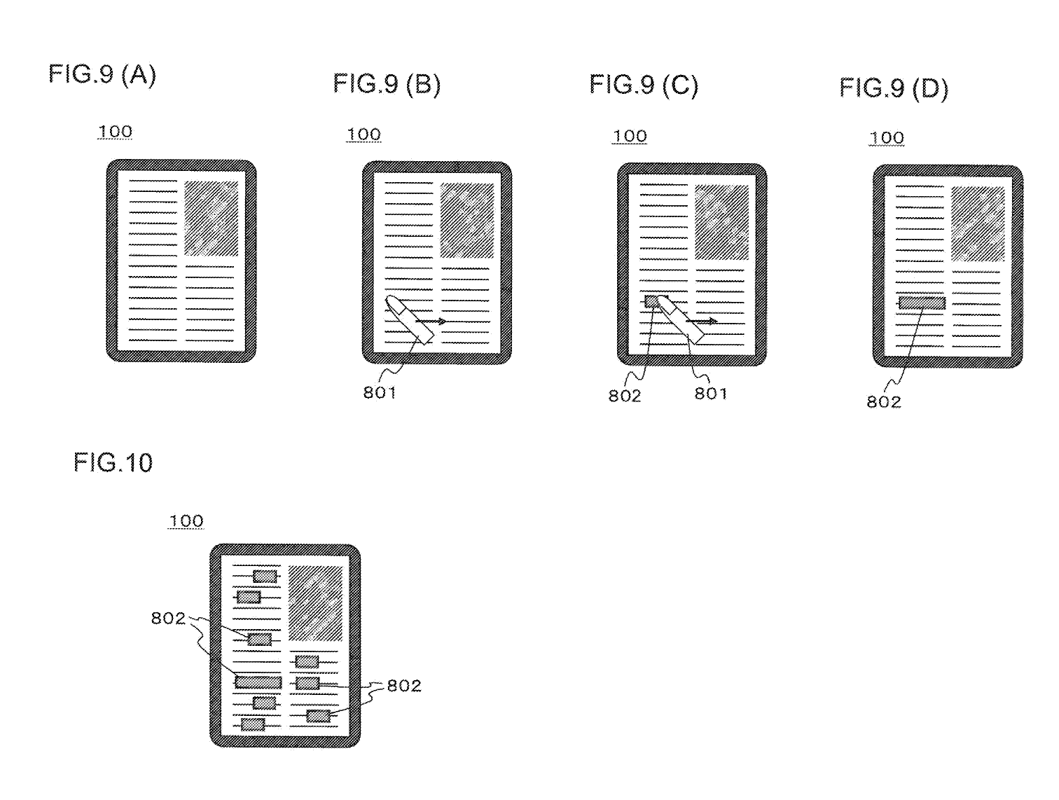

FIGS. 9(A) to 9(D) show a series of operations at the entry mode in the electronic book terminal for study 100 from the user's viewpoint.

FIG. 9(A) is a diagram showing the electronic book terminal for study 100 before the user touches the input device 100. This is in the same state as shown in FIG. 4.

FIG. 9(B) is a diagram showing the state in which the user's finger touches a part of the document of the electronic book content displayed on the display 112. The user moves his finger 801 to the right from this position, touching the display device 112 (the input device 101).

FIG. 9(C) is a diagram showing a state in which the user has moved his finger 801 to the right from the position shown in FIG. 9(B), touching the display device 112 (the input device 101). A part of the marker 802 is displayed.

FIG. 9(D) is a diagram showing a state in which the user's finger 801 is detached from the display device 112 (the input device 101) after the user has further moved his finger 801 to the right from the position shown in FIG. 9(C). The marker 802 is drawn over the document of the electronic book content displayed on the display device 112. A part of the document cannot be read because there is the marker 802. The position in which the marker 802 is displayed is the portion which the user has touched with the finger 801. The user can draw the markers on any position. Therefore, the user can search for a character string to learn (i.e., to memorize) and make the character string nonreadable for learning (i.e., for memorizing).

FIGS. 9(A) to 9(D) show an example such that the number of the markers 802 is only one. A plurality of character strings may be turned nonreadable by drawing a plurality of markers on one document.

FIG. 10 shows an example which displays a plurality of markers. In order to draw the plurality of markers 802, the operation shown in FIGS. 9(A) to 9(D) has to be performed two or more times. At this time, the operation in the entry mode shown in FIG. 6 is repeatedly performed inside the electronic book terminal for study 100.

Thus, the electronic book-based study implement which can be operated by the user's hand is completed.

Next, in a case where the mode is changed to the learning mode (the state 403) by the user operation at the operation mode change unit 103, the operation of the electronic book terminal for study 100 is described.

As shown in FIG. 10, the learning is performed which uses the displayed markers 802 in the state in which the two or more markers 802 are displayed. It is the user that learns using the electronic book terminal for study 100. The user also decides whether to learn. The electronic book terminal for study 100 has three operation modes as described in FIG. 2. When the user wants to learn, the electronic book terminal for study 100 is allowed to change the mode to the learning mode (the state 403).

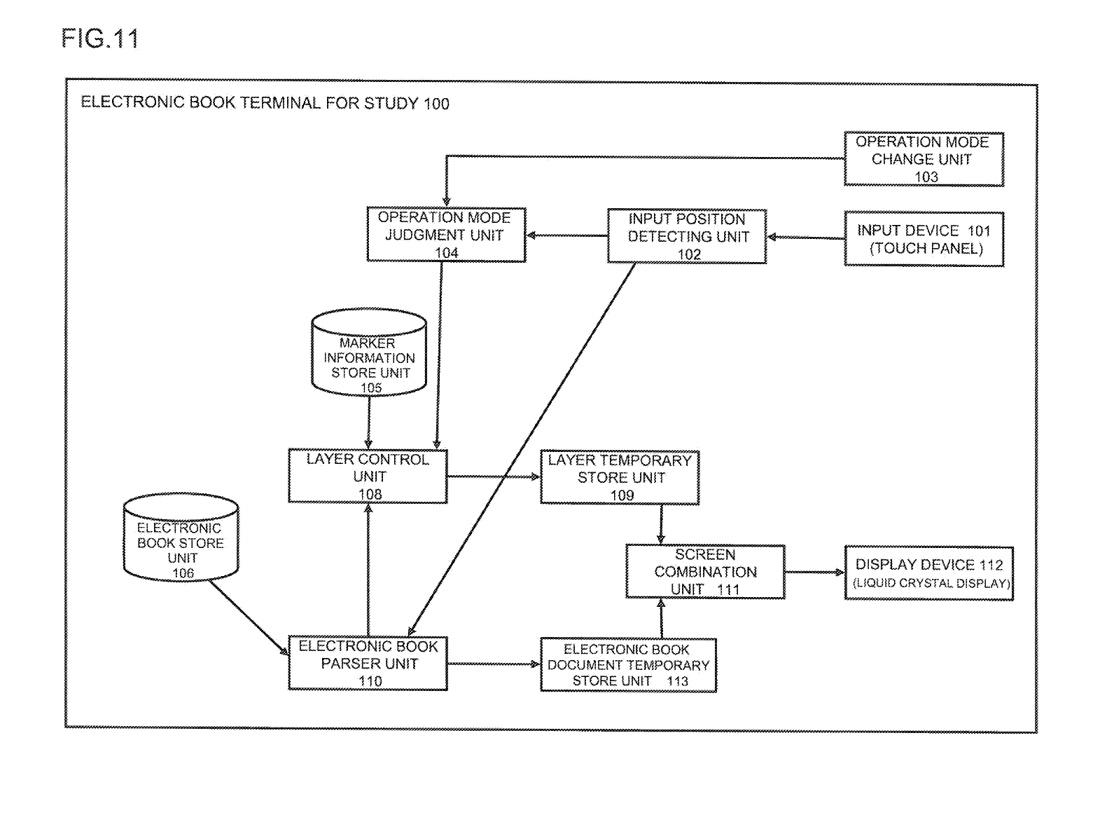

With regard to the block diagram of the electronic book terminal for study 100 in FIG. 1, the connection composition in the learning mode (the state 403) is shown in the block diagram in FIG. 11. The operation at the learning mode is described by using FIG. 6 as well. The operation change unit 103 performs the change to the learning mode (the state 403) in accordance with the operation by the user's hand.

When the user touches the input device 101 after the operation mode change unit 103 changes the mode to the learning mode, the user can create the state in which the markers drawn on the layer are not displayed, thereby making the characters under the markers visible. The markers that are not displayed are such markers which are positioned above, on sentences, a position which the user touched.

The input device 101 receives user operation (step S601 in FIG. 6). The method of receiving the user operation by the input device 101 is the same as the method at the entry mode. The input position detecting unit 102 changes the input of the user operation received by the input device 101 into the information of the input position (step S602).

When the input of the user operation is detected, the operation mode judgment unit 104 judges which mode the present operation mode is among the three operation modes in FIG. 2 (step S603). Here, the case is being described in which a setup of the user in the operation mode change unit 103 is directed to the learning mode (the state 403), and the learning mode will be further described. Reference is made to the appropriate description applicable, for the operations of the other operational modes.

At the learning mode (the state 403), the layer control unit 108 reads out, from the marker information store unit 105, only the information of the predetermined markers drawn on the sentences, the positions of which are below the position on sentences detected by the input position detecting unit 102 based on a touch of the user. And the layer control unit 108 creates the layer to which the markers are added (step S610).

When the marker information is stored at the entry mode, the marker information thus must be stored in the marker information store unit 105 along with the position information of the electronic book content for every electronic book contents. At the learning mode, the layer control unit 108 picks up, from the marker information store unit 105, only the information on the markers drawn on the predetermined character strings, the positions of which are below the position, on sentences, detected by the input position detecting unit 102 based on a touch of the user, among the character strings included in the document of the electronic book content displayed on the display device 112.

The marker information of other documents of the same electronic book content, which are not being displayed on the display device 112, is not required at this time.

An example of the judgment method concerning the above and below, on sentences, with respect to the position touched by the user in the layer control unit 108 is described.

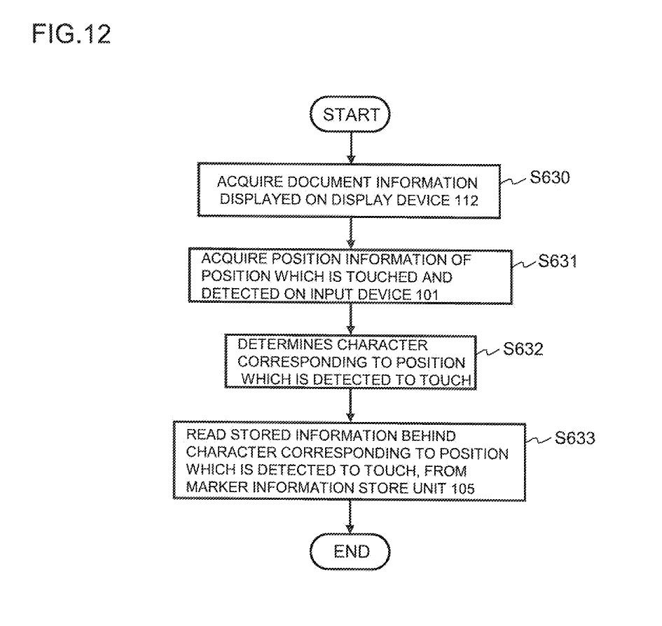

FIG. 12 shows a flow of operation of the judgment processing (step S610) of picking up only the information on the predetermined markers, the positions of which are below the position touched by the user, in the layer control unit 108.

The layer control unit 108 acquires the position information of the position touched by the user on the input device 101, which is detected by the input position detecting unit 102 (step S631), while acquiring the document information of the electronic book content displayed on the display device 112 from the electronic book parser unit 110 (step S630).

The character corresponding to the position which is touched by the user on the input device 101 is determined by referring to the document information acquired from the electronic book parser unit 110 (step S632).

For example, when there is, among the characters displayed on the display device 112, a character at a part of the display area which overlaps with a circular area of a predetermined size centered at the position touched by the user, it is decided that the character should be a character corresponding to the position which is touched by the user. When there is no character at a part of the display area which overlaps with the circular area of the predetermined size, i.e., when the user touches a space position between the lines in which characters are not displayed, it is decided that the character (hereafter, called a “last character”) immediately above the space position touched should be a character corresponding to the position touched by the user. When there is no character on the left of the touched position, the character which is above the touched position and is nearest to the touched position can be judged to be the last character. Thus, the last character can be determined.

Therefore, even when there is no character in the neighborhood area of the position touched by the user, the character corresponding to the position touched by the user is always determined in step S632.

The character which is judged to be the character corresponding to the position touched by the user in step S632 by the layer control unit 108 corresponds to an example of characters corresponding to a second position directed in a second mode according to the present invention.

The layer control unit 108 reads out only the information of the markers below the character corresponding to the position touched by the user, which is determined in step S632 (step S633), referring to the position information and the order information of the markers stored in the marker information store unit 105.

The layer control unit 108 writes a marker in a layer based on the picked up marker information. This layer is a layer for drawing on the document of the electronic book content to be displayed on the display device 112. The layer control unit 108 creates the layer of one sheet including two or more pieces of marker information.

When the electronic book terminal for study 100 has the function of displaying a plurality of pages in one screen on the display device 112, or when the electronic book terminal for study 100 has the scaling function for the document of the electronic book content, the layer has to be created also in consideration of the displaying position of a plurality of pages or the position of the resized document of the electronic book content.

The layer created by the layer control unit 108 is stored in the layer temporary store unit 109 (step S607). When there is already a layer stored in the layer temporary store unit 109, the stored layer is deleted and the newly created layer is stored.

The screen combination unit 111 combines (a) the document of the electronic book content which has been expanded by the electronic book parser unit 110 and is stored in the electronic document temporary store unit 113, and (b) the layer stored in the layer temporary store unit 109 (step S608). The document of the electronic content which has been expanded by the electronic book parser unit 110 and is stored in the electronic document temporary store unit 113 is the same document as what was stored before the user touches the input device 101.

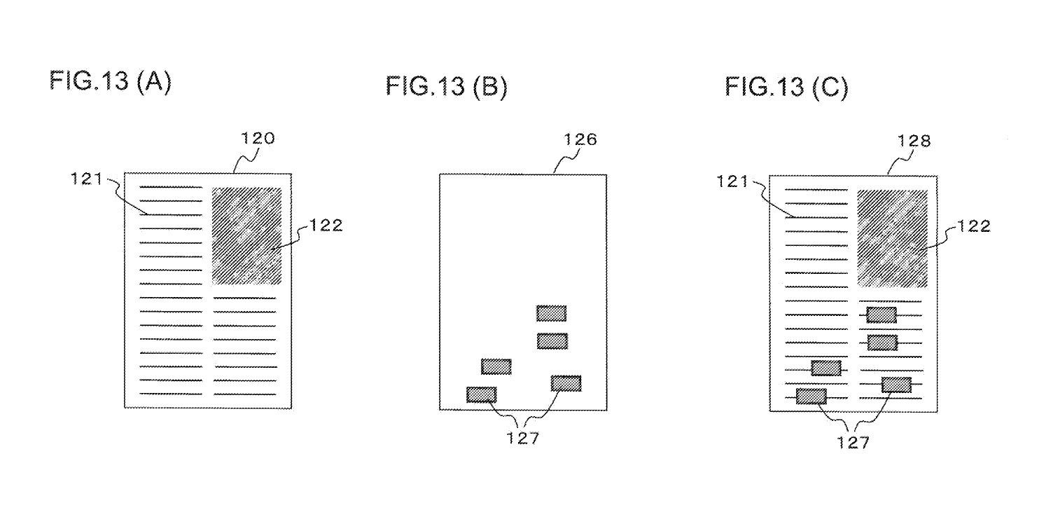

The combination performed by the screen combination unit 111 of the document of the electronic book content and the layer is described using FIGS. 13(A) to 13(C). In FIGS. 13(A) to 13(C), the components that are the same as those in FIGS. 8(A) to 8(C) are denoted by the same reference numerals.

FIG. 13(A) is a diagram showing the document 120 of the electronic book content stored in the electronic book document temporary store unit 113. The diagram shown in FIG. 13(A) has the same description as the screen which is displayed on the display device 112 of the electronic book terminal for study 100 shown in FIG. 4.

FIG. 13(B) is a diagram showing the layer 126 stored in the layer temporary store unit 109. A plurality of markers 127 for hiding a part of the sentences 121 is described. Only the markers 127 drawn on the predetermined character strings, the positions of which are below the position touched by the user, on sentences, are described on the layer 126. The other portion of the layer 126 is of transparent color, and the markers 127 are displayed over the document 120 of the electronic book content.

FIG. 13(C) is a diagram showing a picture 128 obtained through combination by the screen combination unit 111. The picture 128 is a picture obtained through combination of the document 120 of the electronic book content shown in FIG. 13(A) and the layer 126 shown in FIG. 13(B). The markers 127 are displayed over the document 120 of the electronic book content. A part of the document 120 of the electronic book content is hidden by this. Therefore, the document 120 of the electronic book content must be located under the layer 126 in the combination. The screen combination unit 111 processes this combination.

Returning to FIG. 6, further description is provided. The picture 128 obtained through combination by the screen combination unit 111 is displayed on the display device 112 (step S609).

Thereby, since the markers which are in the portion above the position touched by the user, on sentences, disappear and are not displayed, the character strings under the markers that disappeared can be read. Therefore, the study can be continued.

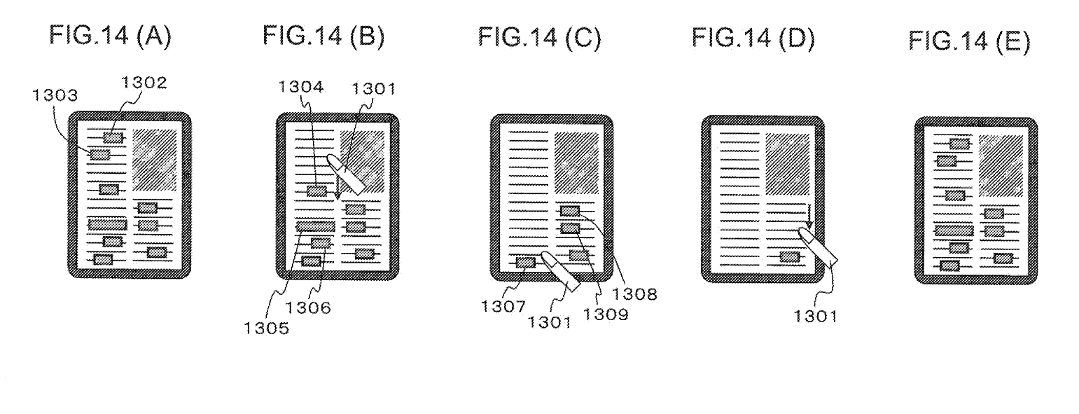

The user operation and the display in the electronic book terminal for study 100 at the learning mode are described using FIGS. 14(A) to 14(E).

FIG. 14(A) is a diagram showing the electronic book terminal for study 100 in the state in which the user is not touching the input device 101 during the learning mode. The markers are drawn on the display device 112 so that the markers hide a part of the document of the electronic book content.

FIG. 14(B) is a diagram showing the state in which the user's finger 1301 touches a part of the display device 112. The input device 101 detects the input by the user's finger 1301 when the user touches the display device 112. The markers (the marker 1302 and the marker 1303 in FIG. 14(A)) which were hiding the character strings included in the sentences above the position touched by the user's finger 1301, on sentences, are not displayed now.

FIG. 14(C) is a diagram showing the state in which the user's finger 1301 slides to the bottom where the user's finger 1301 pointing to a position in FIG. 14(B) continues to touch the display device 112.

Since the position the user's finger 1301 touches moves gradually, the position of the user's finger 1301, which is inputted into the input device 101, also changes gradually. The area of the sentences above the position which is touched by the user's finger 1301, on sentences, also changes. Therefore, the markers that were displayed disappear one by one so as not to be displayed according to the movement of the user's finger 1301. That is, in FIG. 14(B) to FIG. 14(C), the marker 1304, the marker 1305, and the marker 1306 disappear one by one in this order so as not to be displayed.

FIG. 14(D) is a diagram showing a state in which the user's finger 1301 touches the middle of the column on the right-hand side of the sentences composed with two columns. Because the position the user's finger 1301 touches has further changed compared with that in FIG. 14(C), the position of the user's finger 1301, which is inputted into the input device 101, also changes. The area of the sentences above the position which is touched by the user's finger 1301, on sentences, also changes, and the number of the markers that disappear increases. That is, in FIG. 14(C) to FIG. 14(D), the marker 1307, the marker 1308, and the marker 1309 disappear one by one in this order so as not to be displayed.

As shown in FIGS. 14(B) to 14(D), the state of display or non-display for the markers is changed according to the position the user's finger 1301 touches. The electronic book terminal for study 100 has a feature enabling the answers to be checked one after another when the user touches the display device 112 with the finger so that the sentences to be learned changes during study.

A plurality of markers, which are located above the position touched by the user's finger 1301, on sentences, is allowed to disappear so as not to be displayed at the same time. The terminal has a feature such that the user does not need to allow the markers to disappear individually when the user wants to refer to the related items or the like collectively. This feature is helpful, for example, in a case in which the user wants to check the items concerning the era, the place and the like collectively with a general's name.

FIG. 14(E) is a diagram showing a state in which the user's finger 1301 is detached from the display device 112.

The input device 101 can detect, as an input, the user detaching the finger 1301 from the display device 112, so the markers to be displayed are corrected. The sentences above the touched position, on sentences, then cannot be considered because the user's finger 1301 is not touching the display device 112. All of the markers set on the document of the displayed electronic book content are displayed, as in the state shown in FIG. 14(A).

When the user detaches the finger 1301 from the display device 112 in the state shown in FIG. 14(D), the state does not necessarily have to be changed into the state of FIG. 14(E) immediately. Instead, the user's finger 1301 may be detected again being detached so that the state is then changed into the state of FIG. 14(E) after the state shown in FIG. 14(D) is maintained for a predetermined period (e.g. 1 second).

The operation of allowing the markers, which were hiding the character strings included in the sentences above the position touched by the user's finger 1301, on sentences, to disappear so as not to be displayed, and enabling the character strings in the relevant portion to be viewed corresponds to an example of an operation making such characters possible to be viewed that were made impossible to be viewed at a second operation mode according to the present invention.

In the first embodiment, the position of the character string which is hidden by the marker is used for the display control of the marker. The feature is described by using FIG. 14(C) as an example.

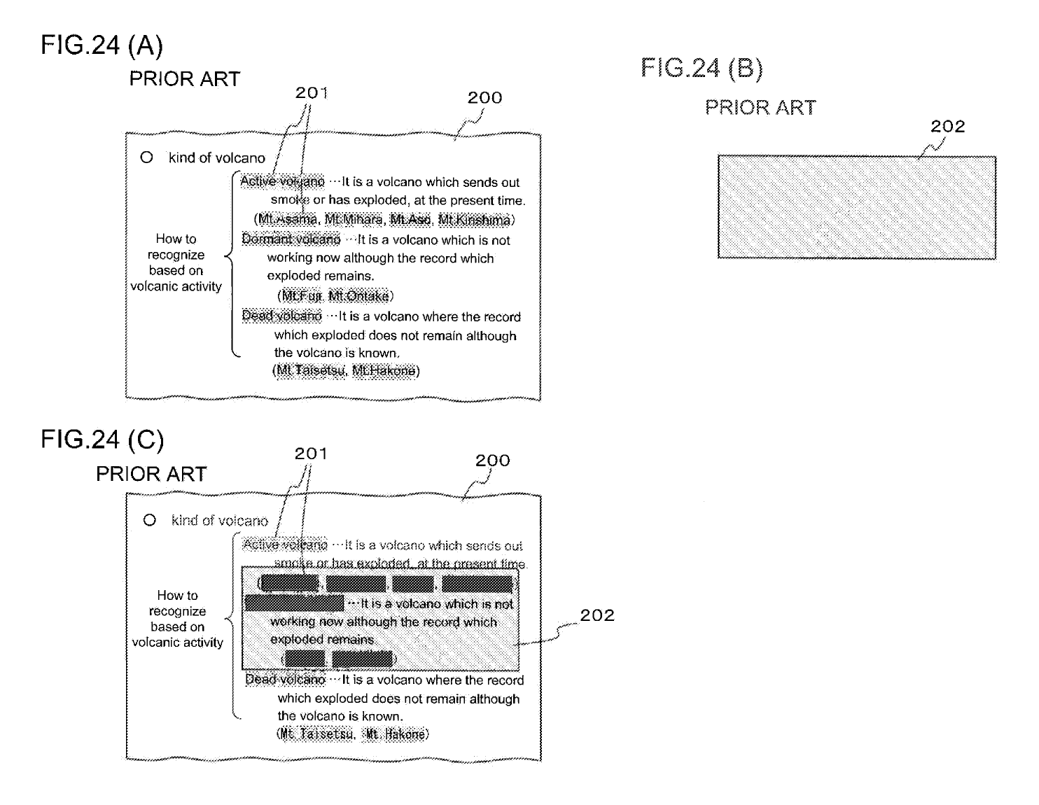

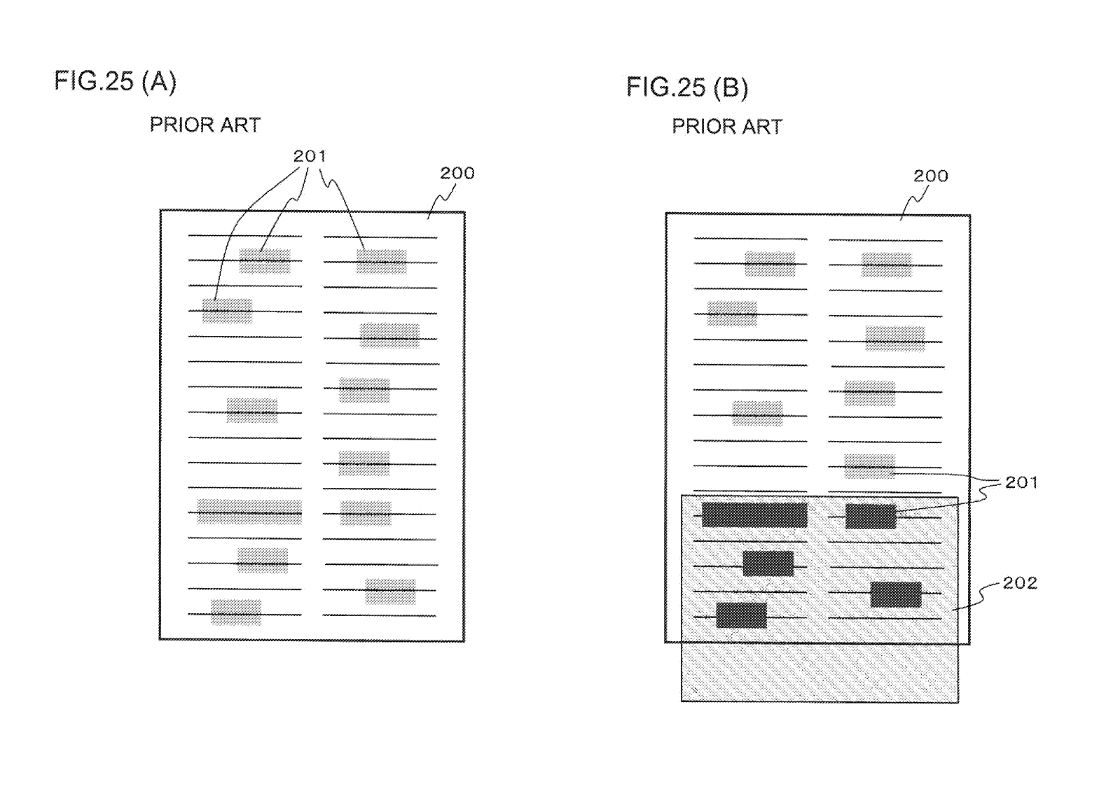

In the case of the study implement using the red pen and the green check sheet 202 with the books of paper in Japanese Patent Application Laid-Open No. S56-035164 described by using FIGS. 24(A) to 24(C), the state of display or non-display is dependent on the shape of the check sheet 202. In the case of the study implement described in Japanese Patent Application Laid-Open No. S56-035164, it is difficult to create the state as shown in FIG. 14(C) because the shape of the check sheet 202 is approximately a rectangle as described using FIG. 25(A) and FIG. 25(B). When the check sheet 202 is slid from the top to the bottom and the marker 1305 and the marker 1306 disappear, then the marker 1308 and the marker 1309 also disappear. A problem of the study implement described in Japanese Patent Application Laid-Open No. S56-035164 is that markers hiding a part below the sentence, also disappear in many cases when the check sheet 202 is slid.

By hiding the words of the sentences or a part of the sentences for learning, the learning can be effectively continued in the nature of things because the portion which is not hidden serves as a hint. Therefore when learning, the user guesses the hidden portion according to the part above or below the hidden portion and the user displays the hidden portion, thereby comparing the guessed portion with displayed portion, and continues the learning, checking whether his guess is correct. Therefore, it is a big problem that an answer can be viewed beforehand.

The display or non-display is decided by using the context of the sentences (i.e., flow direction of the sentences) in the first embodiment. Therefore, when the document of the electronic book content composed with two columns as shown in FIG. 14(C) is used, efficient learning can be performed.

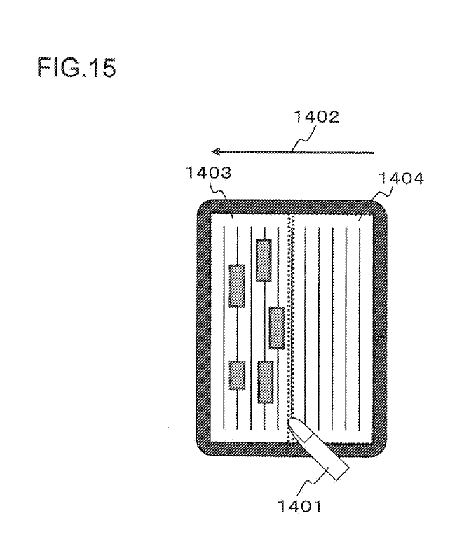

FIG. 15 is a diagram showing areas where the marker is displayed or the marker is not displayed, when sentences by vertical writing is displayed on the electronic book terminal for study 100 at the learning mode according to the first embodiment.

The electronic book terminal for study 100 of the first embodiment uses the order information indicating the context of the sentences. Even when the document is one by vertical writing as shown in FIG. 15, the electronic book terminal for study 100 can judge correctly a marker display area 1403 and a marker non-display area 1404, and can display them appropriately with respect to the position touched by the user's finger 1401 according to a flow direction of sentences 1402.

The electronic book terminal for study 100 of the first embodiment can change the display or non-display of the markers appropriately by using the context of the sentences (i.e., flow direction of the sentences) without being influenced by the layout of the document of the electronic book content.

The document composed with two columns by horizontal writing shown in FIGS. 14(A) to 14(E) or the document by vertical writing shown in FIG. 15 is only one example of the layout of the document of the electronic book content.

A marker can be specified in advance so that the display or non-display of the marker is changed by touching the specified marker directly. When all of the markers which exist above the position touched by the user, on sentences, are allowed to disappear so as not to be displayed, the operation can be easy and the operation system suitable for long study is realized. When, regarding a part of the markers, the display or non-display is allowed to be changed individually, a variation can be given to the user's study method.

In the first embodiment, the markers above the position touched by the user's finger, on sentences, are allowed to disappear so as not to be displayed at all. However, when the marker is not displayed at all, it may be hard to know where the relevant position was. In order to cope with such a problem, the marker drawn on the sentences above the position touched by the user can be colored with a translucent color so that the marker and the character under the marker are viewed. Also, in order to allow a character to be readable, the edge of the marker can be provided a frame with the inside of the frame transparent.

In these cases, the marker information on the markers above the position indicated by the user has to be acquired when the layer control unit 108 creates the layer. The markers have to be drawn so that the filling state or edge of the marker above is different from that of the marker below.

Also, composition is considered such that the following three states are mutually switchable: a first state in which the markers above the position touched by the user's finger on sentences are allowed to disappear so as not to be displayed at all; a second state in which the markers are displayed but the character strings under the markers are not illegible; and a third state in which the markers are displayed and the character strings under the markers are completely illegible. Switching can be performed by a toggle, for example, from the first state to the second state, from the second state to the third state, and from the third state to the first state, according to touches of the user's finger.

The first state can be the state of the electronic book content as it is. The second state is the state in which the markers are displayed on an important part such as the part to be memorized or the like in the electronic book content but the character strings under the markers are not illegible. In the second state, the study using the electronic book content can be continued by referring to the important character strings or the character strings to be memorized. The third state is the state in which the markers are displayed and the important character strings or the character strings to be memorized are completely illegible. In the third state, the study using the electronic book content can be continued by remembering the important character strings or the character strings to be memorized.

### Second Embodiment

The first embodiment shows an example which adds the markers only to the character strings. An example such that the markers are added also to the portions other than the character strings is described in a second embodiment of the present invention.

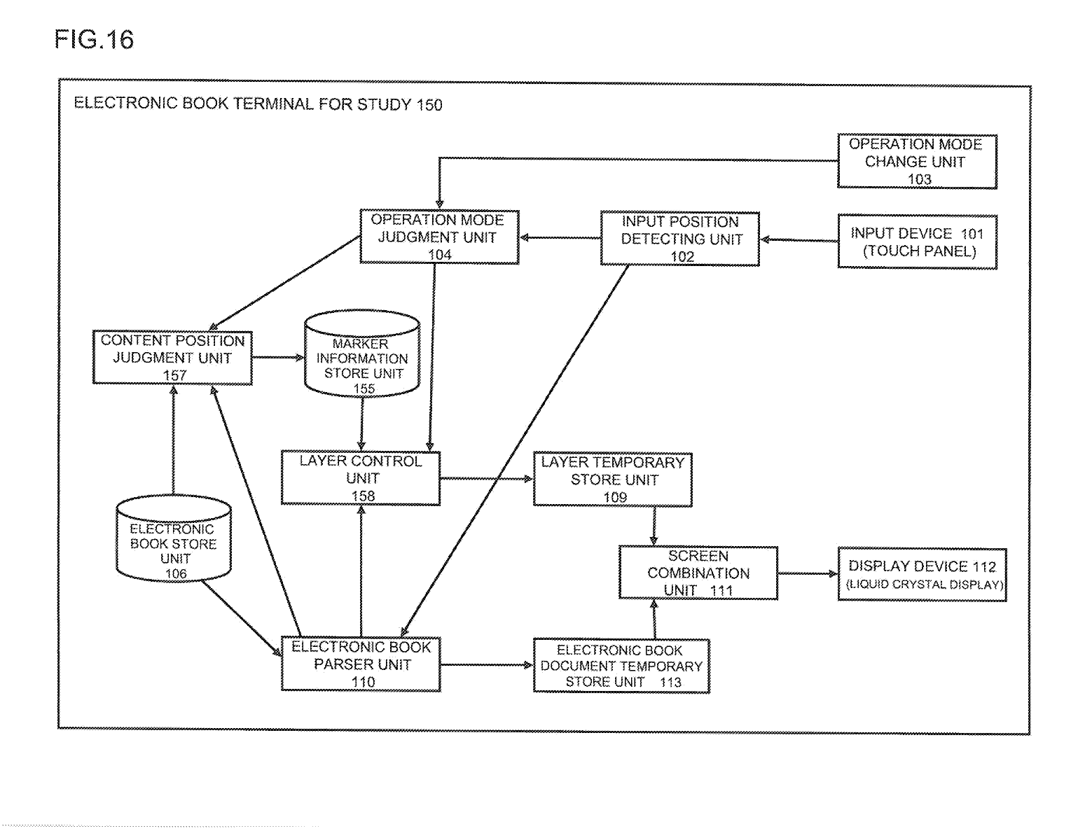

FIG. 16 is a block diagram of an electronic book terminal for study according to the second embodiment. In FIG. 16, the components that are the same as those in FIG. 1 are denoted by the same reference numerals.

A content position judgment unit 157 in an electronic book terminal for study 150 in the second embodiment has a function similar to that of the character position judgment unit 107 in the first embodiment shown in FIG. 1, which judges the position on sentences corresponding to the position of the input device 101 touched by the user. The content position judgment unit 157 further has a function of judging the position on sentences corresponding to the image data other than the sentences in the document.

The image data other than the sentences means data other than characters, such as data of a chart, a graph, a photograph, an illustration or the like.

The aforementioned image data corresponds to an example of another content according to the present invention.

When the image data in the document is selected by the user, i.e. when the user touches the portion of the image data displayed on the document, the content position judgment unit 157 decides that the image data should be the object to be concealed by a marker. And the content position judgment unit 157 stores, into a marker information store unit 155, the marker information and the position information of the image data on sentences.

When the marker is added to the image data, a layer control unit 158 creates, according to the information read from the marker information store unit 155, a layer so that a marker is added to the image data portion of the layer. And the layer control unit 158 stores the created layer in the layer temporary store unit 109.

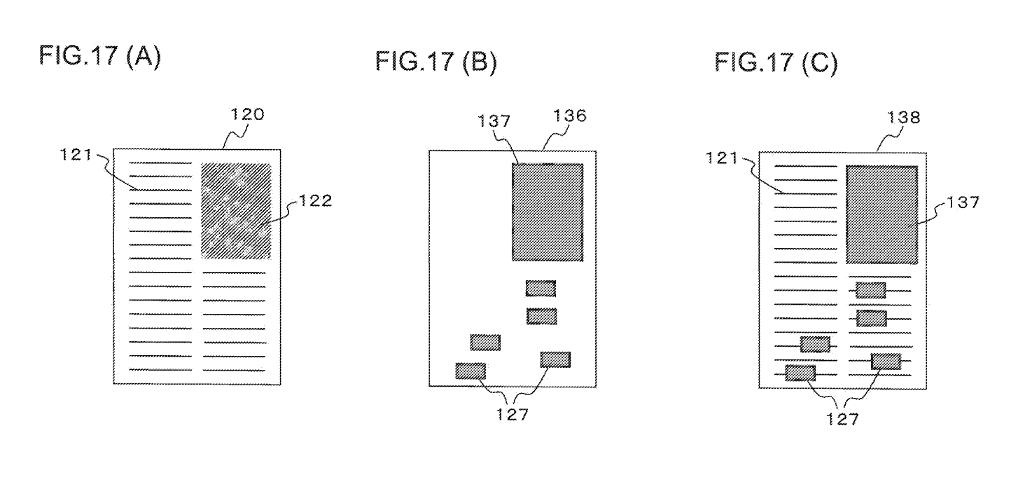

The combination of the document of the electronic book content and the layer, which is performed by the screen combination unit 111 in the second embodiment, is described using FIGS. 17(A) to 17(C). In FIGS. 17(A) to 17(C), the components that are the same as those in FIGS. 13(A) to 13(C) are denoted by the same reference numerals.

FIG. 17(A) is a diagram showing the document 120 of the electronic book content stored in the electronic book document temporary store unit 113. The diagram shown in FIG. 17(A) has the same description as the screen which is displayed on the display device 112 of the electronic book terminal for study 100 in the first embodiment shown in FIG. 4.

The content position judgment unit 157 judges the position with respect to the sentences of the image data other than the character strings, according to the position in the document displayed on the display device 112. That is, the order of the image data is determined according to the layout in the document.

For example, in the case of the document composed with two columns by horizontal writing shown in FIG. 17(A), an illustration 122 is displayed on the top position on the right-hand side of the two columns. It is thus decided that the order of the illustration 122, which is image data, should be below the character at the right end of the lowest line of the sentences on the left-hand side of the two columns and above the character at the left end of the top line of the sentences on the right-hand side.

FIG. 17(B) is a diagram showing the layer 136 stored in the layer temporary store unit 109. An area marker 137 is described on the portion corresponding to the illustration 122 in the document 120 in addition to a plurality of markers 127 for hiding a part of the sentences 121. Because the portion other than the marker 127 and the area marker 137 is of transparent color, the markers 127 and the area marker 137 can be displayed over the document 120 of the electronic book content.

FIG. 17(C) is a diagram showing a picture 138 obtained through combination by the screen combination unit 111. The picture 138 is a picture obtained through combination of the document 120 of the electronic book content shown in FIG. 17(A) and the layer 136 shown in FIG. 17(B). The markers 127 and the area marker 137 are displayed over the document 120 of the electronic book content. A part of the document 120 of the electronic book content is hidden by this. Therefore, the document 120 of the electronic book content must be located under the layer 136 in the combination. The screen combination unit 111 processes this combination.

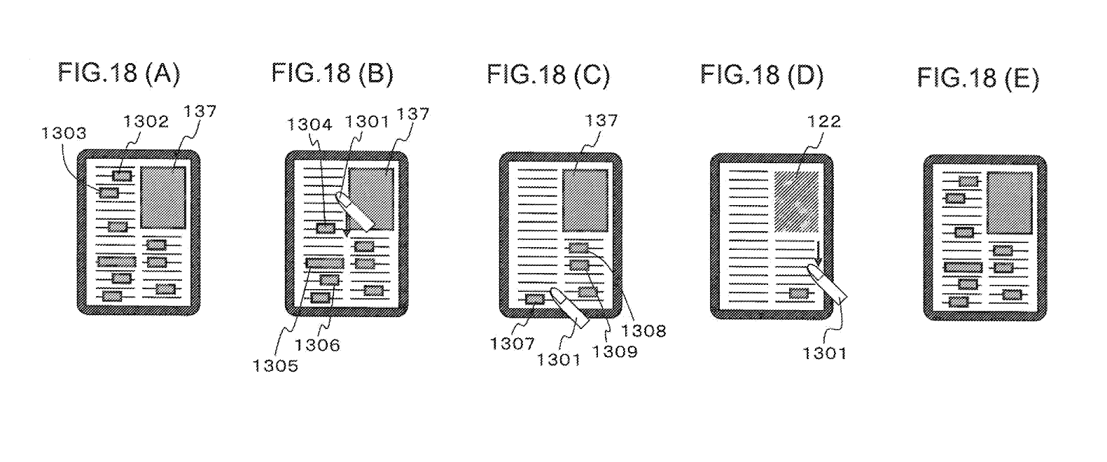

The user operation and the display in the electronic book terminal for study 150 at the learning mode according to the second embodiment are described using FIGS. 18(A) to 18(E). The components that are the same as those in FIGS. 14(A) to 14(E) described in the first embodiment are denoted by the same reference numerals.

Here, it is assumed that the user has set the portion of the illustration 122 to the area in which the marker is added at the entry mode.

FIG. 18(A) is a diagram showing the electronic book terminal for study 150 in the state in which the user is not touching the input device 101 during the learning mode. The markers are drawn on the display device 112 so that the markers hide a part of the document of the electronic book content.

FIG. 18(B) is a diagram showing the state in which the user's finger 1301 touches a part of the display device 112. The input device 101 detects the input by the user's finger 1301 when the user touches the display device 112. The markers (the marker 1302 and the marker 1303 in FIG. 18(A)) which were hiding the character strings included in the sentences above the position touched by the user's finger 1301 on sentences are not displayed now.

FIG. 18(C) is a diagram showing the state in which the user's finger 1301 slides to the bottom where the user's finger 1301 pointing to a position in FIG. 18(B) continues to touch the display device 112.

Since the position the user's finger 1301 touches moves gradually, the position of the user's finger 1301, which is inputted into the input device 101, also changes gradually. The area of the sentences above the position which is touched by the user's finger 1301 also changes. Therefore, the markers that were displayed disappear one by one so as not to be displayed according to the movement of the user's finger 1301. That is, in FIG. 18(B) to FIG. 18(C), the marker 1304, the marker 1305, and the marker 1306 disappear one by one in this order so as not to be displayed.

FIG. 18(D) is a diagram showing a state in which the user's finger 1301 touches the middle of the column on the right-hand side of the sentences composed with two columns. Because the position the user's finger 1301 touches has further changed compared with that in FIG. 18(C), the position of the user's finger 1301, which is inputted into the input device 101, also changes. The area of the sentences above the position which is touched by the user's finger 1301 also changes, and the number of the markers that disappear increases. That is, in FIG. 18(C) to FIG. 18(D), the marker 1307, the marker 1308, and the marker 1309 disappear one by one in this order so as not to be displayed. At this time, because the user's finger 1301 moves to the right-hand side from the left-hand side of the two columns, the area marker 137, the order of which is set above the sentences on the right-hand side, also disappear. Therefore, the illustration 122 can be viewed by the user.

FIG. 18(E) is a diagram showing a state in which the user's finger 1301 is detached from the display device 112.

The input device 101 can detect, as an input, the user detaching the finger 1301 from the display device 112, so the markers to be displayed are corrected. The sentences above the touched position on sentences then cannot be considered because the user's finger 1301 is not touching the display device 112. All of the markers set on the document of the displayed electronic book content are displayed, as in the state shown in FIG. 18(A).

Because the marker can be put on the whole image data, a bigger effect can be produced.

The following electronic book provided for use of infant study is a concrete example. In the electronic book content, a “picture of an apple” is provided beside the character string of an “apple”. A study implement can be considered such that the infant is directed to draw a “picture of an apple” when the “picture of an apple” can be not viewed by adding the marker. After the infant draws a “picture of an apple”, the “picture of an apple” of the electronic book content is displayed.

The order of the image data other than the sentences does not necessarily have to be determined according to the displaying position in the document (i.e. the layout) as above. A term in the sentences which indicates the image data can be matched with the image data so that the order of the image data other than the sentences is the order of the position of the term in the document.

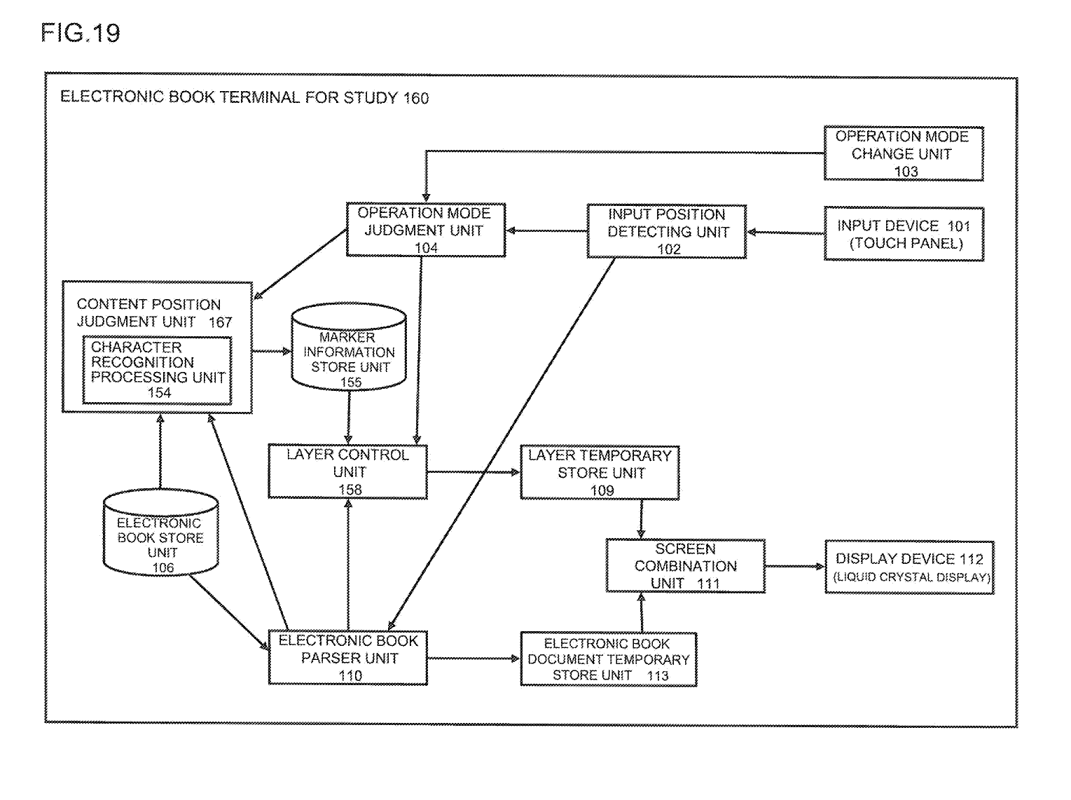

FIG. 19 shows a block diagram of the electronic book terminal for study which determines the order of the image data by matching the image data with the term in the sentences which indicates the image data. The components that are the same as those in FIG. 16 are denoted by the same reference numerals.

A content position judgment unit 167 in the electronic book terminal for study 160 shown in FIG. 19 has a character recognition processing unit 154 which recognizes a character image included in the image data as a character.

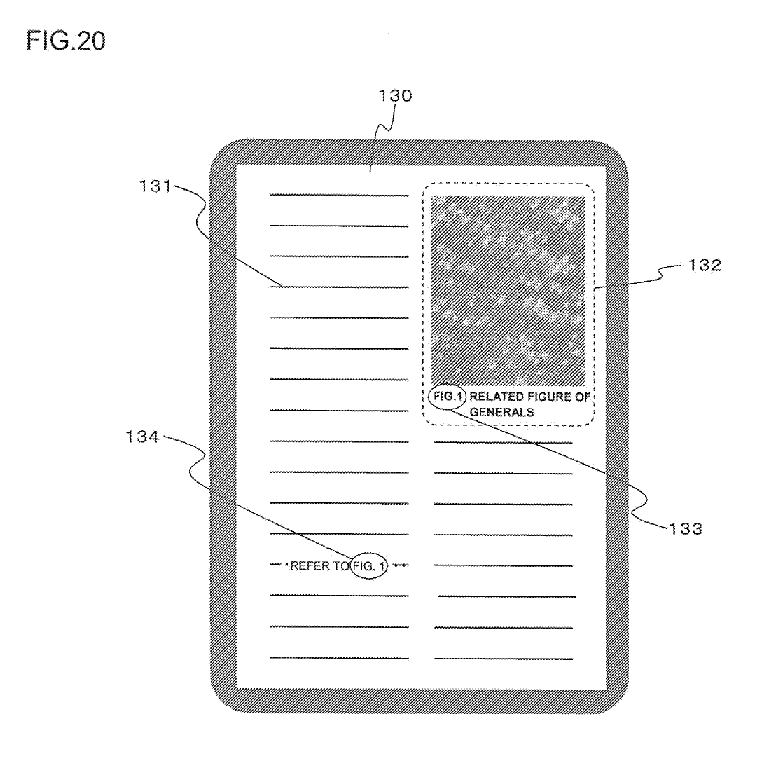

FIG. 20 shows a state where a document 130 of the electronic book content is displayed on the display device 112 of the electronic book terminal for study 160.

The document 130 displayed on the display device 112 shown in FIG. 20 has sentences 131 with a composition of two columns by horizontal writing, and an illustration 132 is inserted in the upper right.

The portion enclosed with the dashed line in FIG. 20 is the image data 132. In FIG. 20, the image data 132 includes a drawing shown with the slash and a term 133 which indicates the drawing.

A term agreeing with the term 133 which indicates the drawing is included in the sentences 131. The term agreeing with the term 133 which shows the drawing corresponds to the term “FIG. 1” in the example of FIG. 20.

The term 133 which indicates the drawing corresponds to an example of a term which indicates the another content according to the present invention.

In order to determine the order of the image data 132 on the document 130, the content position judgment unit 167 searches for the character image in the image data 132 by the character recognition processing unit 154. When the content position judgment unit 167 recognizes the character image in the image data 132, the content position judgment unit 167 searches for a character string 134 agreeing with the recognized character string, which is in the sentences 131 in the same document 130. When the character string 134 which agrees with the term is included in the sentences 131 and the content position judgment unit 167 judges that the character string 134 is the term indicating the drawing or the like included in the image data 132, the content position judgment unit 167 decides that the order of the image data 132 should be the same as the order of the character string 134, which agrees with the term, in the sentences 131.

When it has been decided that the order of the image data 132 should be the same order of the character string 134, which agrees with the term, in the sentences 131, the position of the image data 132 is judged as follows. When the position which the user touches on the input device 101 is above the character string 134 on sentences, it is judged that the position of the image data 132 is below the position touched by the user. When the position which the user touches on the input device 101 is below the character string 134 on sentences, it is judged that the position of the image data 132 is above the position touched by the user.

When no character image is recognized in the image data 132, or when a character image is recognized in the image data 132 but no term agreeing with the character image is included in the sentences 131, the content position judgment unit 167 determines the order of the image data 132 on the sentences 131 according to the layout, the same as the content position judgment 157 shown in FIG. 16.

The form of the data stored in the marker information store unit 155 and the operation of the layer control unit 158 in the electronic book terminal for study 160 shown in FIG. 19 are the same as those of the terminal of the electronic book terminal for study 150 shown in FIG. 16. Only the order information of the image data 132 which is stored in the marker information store unit 155 differs from that of the electronic book terminal for study 150.

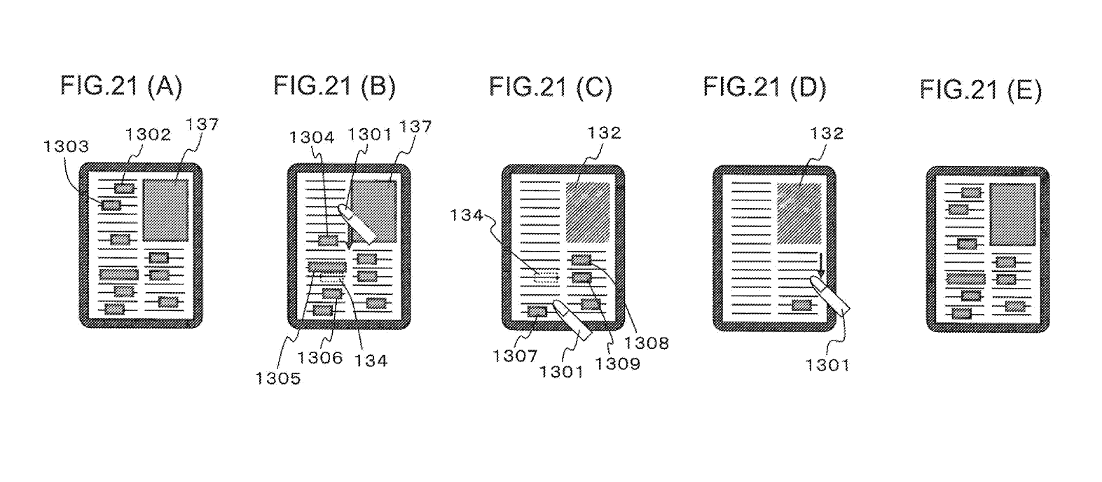

The user operation and the display in the electronic book terminal for study 160 at the learning mode according to the second embodiment are described using FIGS. 21(A) to 21(E). The components that are the same as those in FIGS. 18(A) to 18(E) are denoted by the same reference numerals.

Here, it is assumed that the user has set the portion of the image data 132 to the area in which the marker is added at the entry mode.

FIG. 21(A) is a diagram showing the electronic book terminal for study 160 in the state in which the user is not touching the input device 101 during the learning mode. The markers are drawn on the display device 112 so that the markers hide a part of the document of the electronic book content.

FIG. 21(B) is a diagram showing the state in which the user's finger 1301 touches a part of the display device 112. The input device 101 detects the input by the user's finger 1301 when the user touches the display device 112. The markers (the marker 1302 and the marker 1303 in FIG. 21(A)) which were hiding the character strings included in the sentences above the position touched by the user's finger 1301 on sentences are not displayed now.

Here, the term which indicates the image data 132 is included in the character string 134 between the marker 1305 and the marker 1306. The order of the image data 132 is matched with the order of the character string 134 by the content position judgment unit 167, and the order information is stored in the marker information store unit 155.

FIG. 21(C) is a diagram showing the state in which the user's finger 1301 slides to the bottom where the user's finger 1301 pointing to a position in FIG. 21(B) continues to touch the display device 112.

Since the position the user's finger 1301 touches moves gradually, the position of the user's finger 1301, which is inputted into the input device 101, also changes gradually. The area of the sentences above the position which is touched by the user's finger 1301 also changes. Therefore, the markers that were displayed disappear one by one so as not to be displayed according to the movement of the user's finger 1301. That is, in FIG. 21(B) to FIG. 21(C), the marker 1304, the marker 1305, and the marker 1306 disappear one by one in this order so as not to be displayed. At this time, the layer control unit 158 judges that the user's finger 1301 has moved to the position below the image data 132 corresponding to the position of the character string 134 because the user's finger 1301 moves to the position below the character string 134 from the position above the character string 134 on sentences. The area marker 137 disappears so as not to be displayed and the image data 132 can be viewed.

FIG. 21(D) is a diagram showing a state in which the user's finger 1301 touches the middle of the column on the right-hand side of the sentences composed with two columns. Because the position the user's finger 1301 touches has further changed compared with that in FIG. 21(C), the position of the user's finger 1301, which is inputted into the input device 101, also changes. The area of the sentences above the position which is touched by the user's finger 1301 also changes, and the number of the markers that disappear increases. That is, in FIG. 21(C) to FIG. 21(D), the marker 1307, the marker 1308, and the marker 1309 disappear one by one in this order so as not to be displayed. At this time, because the user's finger 1301 moves only in the area below the character string 134, the state in which the area marker 137 is not displayed is maintained, and the state in which the user can view the image data 132 is maintained.

FIG. 21(E) is a diagram showing a state in which the user's finger 1301 is detached from the display device 112.

The input device 101 can detect, as an input, the user detaching the finger 1301 from the display device 112, so the markers to be displayed are corrected. The sentences above the touched position on sentences then cannot be considered because the user's finger 1301 is not touching the display device 112. All of the markers set on the document of the displayed electronic book content are displayed, as in the state shown in FIG. 21(A).

When the character image other than the term which indicates the drawing or the like included in the image data 132 is recognized in the image data 132, the content position judgment unit 167 can perform, to the recognized character string, the same processing as the processing to the character string included in the sentences 131.

That is, the marker can also be put on the recognized character included in the image data 132 based on selection with the user's finger.

As a concrete example, consider the genealogy of a general in warring states or the like composed of the image data with the marker being put on the names of some generals.

The content position judgment unit 167 which determines the order of the recognized characters included in the image data 132 corresponds to an example of another content order determination unit according to the present invention.

The order of the character strings in the image data 132 can be incorporated in the order of the sentences 131. And the judgment on whether the markers are to be displayed or not by the layer control unit 158 at the learning mode can be performed collectively with respect to the sentences 131 and the character strings included in the image data 132. Alternatively, the order of the context of the sentences can be judged individually with respect to the sentences 131 and the character strings included in the image data 132.

### Third Embodiment

In the first embodiment and the second embodiment, cases where the code data of the characters is included in the data of the electronic book content are described. But, some electronic book contents may not include code data of the characters.

An electronic book content which does not include code data of the characters is described in a third embodiment of the present invention.

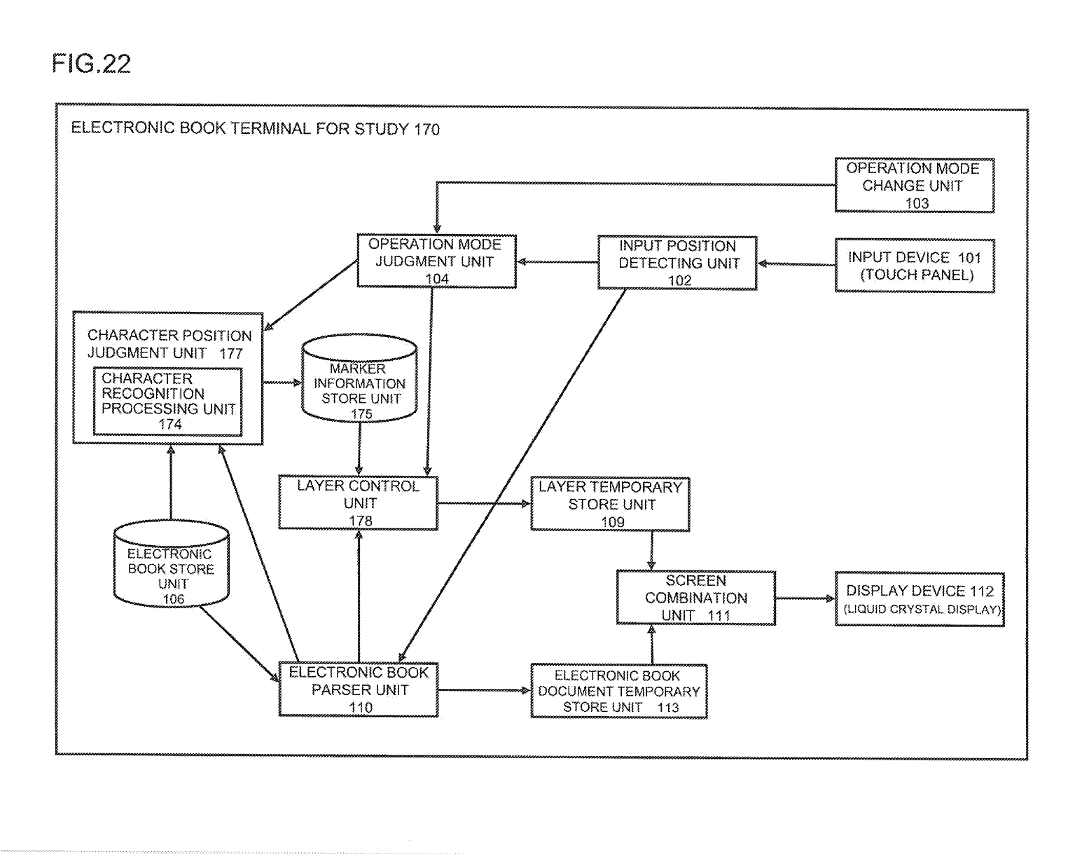

FIG. 22 is a block diagram of an electronic book terminal for study according to the third embodiment. In FIG. 22, the components that are the same as those in FIG. 1 are denoted by the same reference numerals.

A character position judgment unit 177 in an electronic book terminal for study 170 in the third embodiment has a character recognition processing unit 174 which recognizes the character image included in the electronic book content data as a character.

The character position judgment unit 177 acquires the document information from the electronic book parser unit 110, and reads out the electronic book content corresponding to the document from the electronic book store unit 106. The character position judgment unit 177 performs character recognition processing on the data of the electronic book content, and extracts a character string.

The character position judgment unit 177 determines the order of the character string extracted by the character recognition processing on sentences.

The character recognition processing unit 174 corresponds to an example of a character recognition unit according to the present invention. The character position judgment unit 177 corresponds to an example of an order determination unit according to the present invention.

In the case of an electronic book content which does not have columns or the like with the character strings simply continuing, the order of the recognized character strings is determined easily according to the rule of horizontal writing or vertical writing. However, when there are columns, or when the groups of the characters are arranged so that the groups are scattered, the relative order of the groups of the characters has to be determined.

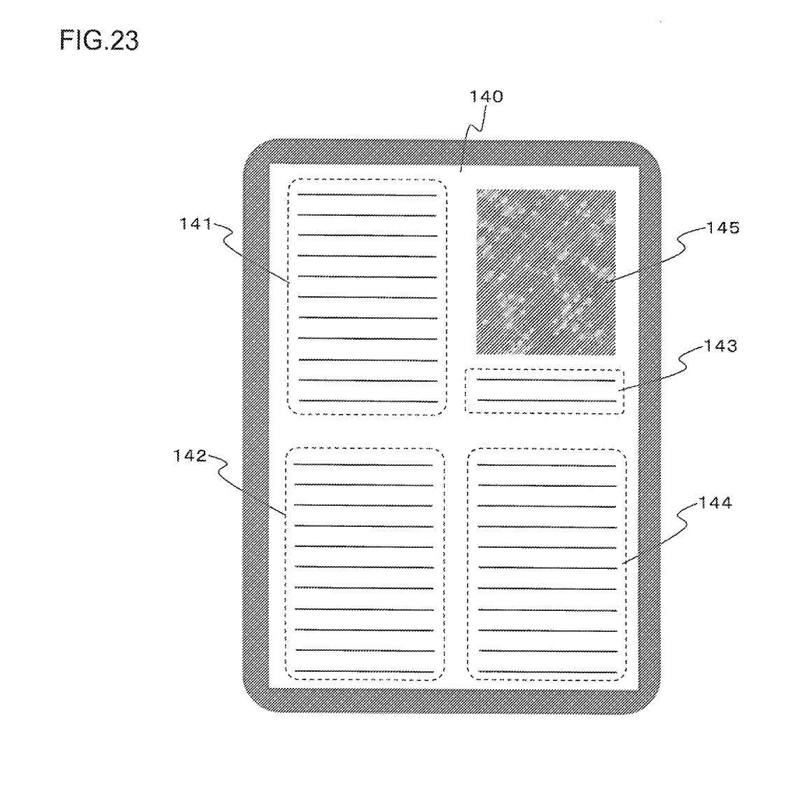

FIG. 23 shows a state where a document 140 of the electronic book content is displayed on the display device 112 of the electronic book terminal for study 170. Here, the original data of the document 140 displayed on the display device 112 consists of one image data.

The document 140 is composed by horizontal writing with two columns horizontally arranged and two columns vertically arranged as shown in FIG. 23. The image 145, on which character recognition cannot be performed, is arranged in the upper right on the document 140.

When the character position judgment unit 177 performs the character recognition processing on the image data of the document 140 by the character recognition processing unit 174, the four character groups 141, 142, 143 and 144, which have character strings recognized to be characters, and the image 145, on which character recognition cannot be performed, are extracted.

The character position judgment unit 177 determines the order of the character groups 141 to 144 and the image 145, on which character recognition cannot be performed, according to a rule decided beforehand based on the layout in the document.

The character position judgment unit 177 judges the layout of each character group or the image according to the distances between their blank portions or the like.

For example, in the arrangement shown in FIG. 23, by detecting the blank portions, it is recognized that the character groups 141 to 144 and the image 145, on which character recognition cannot be performed, are arranged in the areas apart from each other, two areas being vertically arranged and two areas being horizontally arranged. When the character strings are composed by horizontal writing and arranged using vertical and horizontal division, the rule for determining the order of the character groups has been set up beforehand as follows: the upper left, the upper right, the lower left, and the lower right, e.g., in FIG. 23, the character group 141, the character group 143, the character group 142, and the character group 144. The rule is defined so that the order of the images, on which character recognition cannot be performed, is determined according to the arrangement in the document. Therefore, the order of the image 145 to sentences is determined below the character group 141 and above the character group 143.

When the order determination rule on various layout patterns of the character groups has been set up beforehand, the suitable order to sentences can be determined about the documents of various layouts.

The character position judgment unit 177 does not necessarily have to determine the order of character groups according to the layout information indicating such layout patterns. Instead, the order can be determined according to the flow direction of sentences of each character group.

For example, the first and last character string portions of each character group can be extracted so that, between different character groups, the last character string portion and the first character string portion are connected in order to determine the context of the character groups by judging whether a precise sentence expression or natural meaning is obtained or not.

The judgment method of performing judgment according to the flow direction of sentences corresponds to an example of a judgment method which determines the order of the characters according to a meaning of a sentence of the characters according to the present invention.

Plural methods such as (1) the method of performing judgment by the flow direction of sentences between the character groups and (2) the method of performing judgment by the layout pattern can be combined so that more suitable order is determined.

When the sentences are of a type such that the characters are read in the order of the images (i.e., frames) in a comic, the context (i.e., the flow direction of sentences) of sentences can be judged per frame.

The processing concerning the marker information store unit 175 or the layer control unit 178 after the determination of the order on sentences performed by the character position judgment unit 177 is the same as that concerning the marker information store unit 105 or the layer control unit 108 in the electronic book terminal for study 100 in the first embodiment.

In the above, the first embodiment, the second embodiment, and the third embodiment are described according to the functions and the data of the electronic book content. However, the composition of the present invention is not limited to the composition described in each embodiment. The composition obtained by combining suitably the functions described in these embodiments can be used.

The document described in each embodiment can have a complicated layout with many photographs, many charts, or the like. The sentence can include a title, an itemized statement, or the like. Various characters, which constitute the sentences, can be intermingled so that the kind of font, the size, the color or the like differ. The electronic book terminal for study in each embodiment is capable of using characters of any color unlike the study implement in Japanese Patent Application Laid-Open No. 556-035164.

In each embodiment, the character position judgment units 107 and 177, and the content position judgment units 157 and 167 judge the context (i.e., the flow direction of sentences) of sentences. The electronic book parser unit 110 can acquire the context from a meta data which is added to the electronic book content. The electronic book parser unit 110 can analyze the layout from the document of the electronic book content to judge the context (i.e., the flow direction of sentences) of sentences.

In each embodiment, the marker is put on the character string. The character string can be a name of a person, an occurrence in history, an era, a formula of mathematics, a formula of physics or the like. The character string can further contain various parts of speech such as a verb or an adjective in study of English words. That is, the character string, which can be one character, is any character contained in the document of the electronic book content.

The marker can be put on arbitrary portions in the image displayed as the document.

For example, a polygonal line portion indicated in the graph can be traced with the finger so that the polygonal line is hidden. In this case, the range produced by moving the circular portion of predetermined range, which is centered at the portion of the input device 101 the finger touches, can be set as the range of the marker to be added.

The non-transitory computer-readable medium of the present invention is a recording medium having recorded thereon a program of the above-described content display method of the present invention and is a recording medium, the program of which, when read, is used in cooperation with the computer.

The computer according to the present invention described above is not limited to pure hardware such as a CPU and may include firmware, an OS, and peripheral equipment.

As described above, the configuration of the present invention may be realized in terms of software or may be realized in terms of hardware.

A learning method like a conventional learning method which uses a red pen and a check sheet can be realized in the electronic book terminal by using the content display apparatus of the present invention. Furthermore, such a learning method can be performed still more effectively than conventional one.

The content display apparatus of the present invention has a function equivalent to the operation of drawing a marker with a red pen, and further realizes a function equivalent to the operation of moving the check sheet, which can be easily performed also in consideration of the flow direction of sentences in the electronic book.

The content display apparatus of the present invention prevents a situation such that an answer might be accidentally seen earlier during study, and thus the study can be performed efficiently. The operation is easy, and the apparatus is also suitable for long study.

The content display apparatus, the content display method and the like according to the present invention produce an effect such that the portion for which a concealment state is expected is not be viewed accidentally and efficient study can be performed, and are useful as a study implement or the like using electronic books.

What is claimed is:

1. A content display apparatus comprising:
a display unit which displays a content including at least a character string content which has a plurality of characters an order of which is regulated;
a position directions unit which directs a position on the display unit; and
a control unit which controls a display on the display unit, according to the position directed by the position directions unit and the order of the characters; wherein
at a first operation mode, when the position directions unit directs a first position on the display unit, the control unit makes the characters corresponding to the directed first position impossible to be viewed on the display unit; and
at a second operation mode, when the position directions unit directs a second position on the display unit, the control unit makes such characters possible to be viewed that were made impossible to be viewed and that are located before the directed second position under the order.

2. The content display apparatus according to claim 1, wherein
the content includes another content which is displayed on another display area other than a display area for the character string content and an order of the another content to the plurality of the characters is regulated;
the control unit controls the display on the display unit, according to the position directed by the position directions unit and the order of the characters and the order of the another content;
at the first operation mode, when the position directions unit directs the first position on the display unit, the control unit makes the characters or the another content corresponding to the directed first position impossible to be viewed on the display unit; and
at the second operation mode, when the position directions unit directs the second position on the display unit, the control unit makes such characters or the another content possible to be viewed that were or was made impossible to be viewed and that are or is located before the directed second position under the order of the characters and the order of the another content.

3. The content display apparatus according to claim 2, wherein
when the character string includes a term which indicates the another content, the order of the another content is regulated according to an order of the term among the characters.

4. The content display apparatus according to claim 2, comprising another content order determination unit, wherein
when characters are included in the another content, the another content order determination unit determines an order of the characters in the another content displayed on the display unit, according to a displayed position of the characters in the another content and a layout information of the displayed another content.

5. The content display apparatus according to claim 1, further comprising a character recognition unit and an order determination unit, wherein
when the character string content is image data, the character recognition unit recognizes a character in the character string content; and
when the content is displayed on the display unit, the order determination unit determines an order of the characters displayed on the display unit, according to a displayed position of the characters on the display unit, recognized by the character recognition unit and a layout information of the displayed content.

6. The content display apparatus according to claim 5, wherein
the order determination unit determines the order of the characters displayed on the display unit, according to a meaning of a sentence of the characters, in addition to the displayed position of the characters on the display unit and the layout information.

7. The content display apparatus according to claim 1, further comprising
an operation mode change unit which changes the first operation mode and the second operation mode according to an instruction from a user.

8. The content display apparatus according to claim 1, wherein
the control unit makes the character corresponding to the directed first position impossible to be viewed, by displaying a marker on the character corresponding to the first position directed by the position directions unit.

9. The content display apparatus according to claim 8, further comprising an display mode change unit, wherein
the display mode change unit can change the displayed marker in such a manner that the display mode change unit exchanges a first state in which the marker is not displayed, a second state in which the marker is displayed with semitransparent appearance so that the character corresponding to the directed first position can be viewed and a third state in which the marker is displayed so that the character corresponding to the directed first position cannot be viewed.

10. A content display method comprising:
a display step of displaying a content including at least a character string content which has a plurality of characters an order of which is regulated, on a display unit;
a position directions step of directing a position on the display unit;
a first operation step of making the characters corresponding to a first position directed by the position directions step impossible to be viewed on the display unit; and
a second operation step of making such characters possible to be viewed that were made impossible to be viewed and that are located before a second position directed by the position directions step under the order.

11. A non-transitory computer-readable medium having a program stored thereon, wherein the program causes a computer to execute the content display method according to claim 10.
